(19) United States
(12) Patent Application Publication
(10) Pub. No.: US 2004/0023579 A1
(43) Pub. Date: Feb. 5, 2004

(54) Fiber having controlled fiber-bed friction angles and/or cohesion values, and composites made from same

(76) Inventors: Arvinder Pal Singh Kainth, Neenah, WI (US); Richard Norris Dodge II, Appleton, WI (US); Joseph Raymond Feldkamp, Appleton, WI (US); Estelle Anne Ostgard, Appleton, WI (US)

Correspondence Address: KIMBERLY-CLARK WORLDWIDE, INC., 401 NORTH LAKE STREET, NEENAH, WI, 54956

(21) Appl. No.: 10/461,614

(22) Filed: Jun. 13, 2003

Related U.S. Application Data
(60) Provisional application No. 60/399,788, filed on Jul. 30, 2002.

(51) Int. Cl. B32B 27/12; D04H 1/00

(52) U.S. Cl. 442/97; 442/414; 442/417; 442/99; 442/100; 442/118

(57) ABSTRACT

The present invention relates to fiber having controlled fiber-bed friction angles and/or cohesion values. Controlling the fiber-bed friction angle and/or cohesion value of the fiber may allow control of the swelling of the material, the absorbency of the material, and/or the absorbency, resiliency, and porosity of the absorbent composite containing the fiber. The present invention relates to treatments for fiber to manipulate friction angle and cohesion value as well as new fiber materials having the desired friction angle and/or cohesion value characteristics. The present invention also relates to composites and products employing fibers have controlled fiber-bed friction values and/or cohesion values, alone or with other ingredients, including, for example, superabsorbent materials.

### BACKGROUND

People rely on absorbent articles in their daily lives.

Absorbent articles, including adult incontinence articles, feminine care articles, and diapers, are generally manufactured by combining a substantially liquid-permeable topsheet; a substantially liquid-impermeable backsheet attached to the topsheet; and an absorbent core located between the topsheet and the backsheet. When the article is worn, the liquid-permeable topsheet is positioned next to the body of the wearer. The topsheet allows passage of bodily fluids into the absorbent core. The liquid-impermeable backsheet helps prevent leakage of fluids held in the absorbent core. The absorbent core is designed to have desirable physical properties, e.g. a high absorbent capacity and high absorption rate, so that bodily fluids may be transported from the skin of the wearer into the disposable absorbent article.

The present invention relates to fiber, which generally is employed in an absorbent core (also referred to as an absorbent composite), in part to help facilitate transport of fluid into the core. More specifically, the present invention pertains to fiber having a modified friction angle and/or cohesion measured in a fiber bed of the fibrous material. Both the fiber-bed friction angle and cohesion of the fiber (or fibrous material) of the present invention are controllable and follow a predetermined pattern. The present invention also relates to use of the controlled fiber-bed friction angle fibers (and/or fibers having controlled cohesion values) in absorbent composites and absorbent articles incorporating such absorbent composites. Controlling the fiber-bed friction angle of the fiber may allow control of phenomena including, but not limited to: the swelling of any superabsorbent material also employed in the absorbent composite; stresses experienced by the superabsorbent material and/or other ingredients (e.g., fibers) in an absorbent composite; the permeability of an absorbent composite containing the fiber and superabsorbent material; and/or, the absorbency, resiliency, and porosity of the absorbent composite. The present invention relates to treatments for fiber to manipulate fiber-bed friction angle and new fibers having the desired fiber-bed friction angle characteristics. The present invention also relates to absorbent composites and products employing fibers of the present invention alone or with superabsorbent materials, including novel superabsorbent materials disclosed in one or both of two co-pending applications: U.S. Provisional Patent Application Serial No. 60/399877, entitled “Superabsorbent Materials Having Low, Controlled Gel-Bed Friction Angles and Composites Made From The Same,” filed on 30 Jul. 2002 and U.S. Provisional Patent Application Serial No. 60/399794, entitled “Superabsorbent Materials Having High, Controlled Gel-Bed Friction Angles and Composites Made From The Same,” also filed on 30 Jul. 2002. Both of these co-pending applications are incorporated by reference in their entirety in a manner consistent herewith.

As indicated above, the present invention also relates to fibers, and absorbent composites employing fibers, having controlled cohesion values. As described below, controlling the cohesion value of fiber may allow control of phenomena including, but not limited to: the swelling of any superabsorbent material also employed in the absorbent composite; stresses experienced by the superabsorbent material and/or other ingredients (e.g., fibers) in an absorbent composite; the permeability of an absorbent composite containing the fiber and superabsorbent material; and/or, the absorbency, resiliency, and porosity of the absorbent composite.

Absorbent composites used in absorbent articles typically consist of an absorbent material, such as a superabsorbent material, mixed with a composite matrix containing natural and/or synthetic fibers. As fluids enter the absorbent composite, the superabsorbent material swells as it absorbs the fluids. The superabsorbent material contacts the surrounding matrix components and possibly other superabsorbent material as it swells. The full swelling capacity of the superabsorbent material may be reduced due to stresses acting on the superabsorbent materials (e.g., stresses imposed by the matrix on superabsorbent material; external stresses acting on the absorbent composite that comprises a matrix and superabsorbent material, including, for example, stresses imposed on an absorbent composite by a wearer during use; stresses imposed by one portion of the superabsorbent material on another portion of the superabsorbent material, whether directly or indirectly; etc.). Furthermore, stresses acting on an absorbent composite comprising the superabsorbent material may act to reduce interstitial pore volume, i.e., space between superabsorbent material, fibers, other ingredients, or some combination thereof (without being bound to a particular analogy, and for purposes of explanation only, think of a force acting on some unit area of a sponge-like material with pores, with the force per unit area—i.e., stress—acting to reduce the thickness of the sponge-like material, and, therefore, the volume of the pores).

As the superabsorbent material swells, it may rearrange into void spaces of the absorbent composite matrix as well as expand readily against the matrix to create additional void space. Also, as the superabsorbent material swells, stresses acting within and/or on the absorbent composite may increase due—at least in part—to expansion of the superabsorbent material, thereby reducing the pore volume between: fibers, superabsorbent material, other ingredients in the absorbent composite, or some combination there of. The ability to rearrange within the composite matrix, and the magnitude and extent of the stresses acting within and on the composite matrix, depend on several factors specifically including a fiber-bed friction angle and/or cohesion value of the fibers employed in the composite, as well as the gel-bed friction angle and/or cohesion value of any superabsorbent material employed in the composite. In addition, as the superabsorbent material moves within the composite matrix, the superabsorbent material may contact the components, such as fibers and binding materials, of the surrounding matrix. Thus, the frictional and cohesive properties of the fiber may influence the ability of the superabsorbent material to swell and rearrange or move within the matrix, as well as the magnitude and extent of the stresses acting within and on the composite matrix.

It is often desired that the superabsorbent material be able to rotate and translate within the voids of the absorbent composite to allow the superabsorbent material to swell as close to full swelling capacity as is possible within the matrix. Accordingly, there is a need for fiber that may facilitate a superabsorbent material more easily rearranging within the void space of the absorbent composite matrix. There is also a need for a way to control the physical mechanics of the composite that: allow a superabsorbent material to rearrange within the absorbent composite matrix; reduce or minimize the stresses acting within or on the absorbent composite or its ingredient(s); and/or, decrease or minimize the reduction in pore volume that may accompany the build up of said stresses.

### SUMMARY

We have discovered that fiber having controlled fiber-bed friction angles and/or cohesion values meet one or more of these needs. (Note: unless otherwise specified, references to fiber-bed or fiber friction angles, or fiber-bed or fiber cohesion or cohesion values, pertain to properties determined for fiber in a wetted state. See the Definitions section for additional detail on the wetting of fiber for purposes of determining cohesion or friction angle.) Accordingly, the present invention is directed to fiber having controlled fiber-bed friction angles and/or cohesion values. The fiber of the present invention may have fiber-bed friction angles that exhibit controlled fiber-bed friction angles substantially different than fiber-bed friction angles of conventional fiber.

The fiber and/or fiber materials of the present invention may be produced using non-conventional manufacturing processes to obtain desired fiber-bed friction angles and/or cohesion values by treating with additives to increase, decrease, or otherwise control the friction angle of the fiber-bed. Fiber-bed friction angle and cohesion are properties of a fiber bed or fibrous material coming from Mohr-Coulomb failure theory (these properties and this theory are discussed in more detail below). A lower friction angle implies lower inter-particle (e.g., fiber to fiber interaction; fiber to superabsorbent material interaction; etc.) friction.

A lower cohesion value for fiber implies less integrity in the fiber matrix. Fiber of the present invention may be employed alone or with other ingredients, including superabsorbent materials. Suitable superabsorbent materials are disclosed in the two co-pending applications identified and incorporated by reference above.

The fibers and/or fibrous matrix of the present invention may comprise wettable natural fibers having a fiber-bed friction angle of about 35 degrees or less upon wetting. The fibers and/or fibrous matrix may be included into an absorbent composite further comprising a water swellable, water insoluble superabsorbent material. The fibers and/or fibrous matrix has a dry fiber-bed friction angle and a wet fiber-bed friction angle wherein the wet fiber-bed friction angle may be about 80% of the dry fiber-bed friction angle or less. The fibers and/or fibrous matrix may have a wet fiber-bed cohesion value of about 5,000 Pascals or less.

The fibers and/or fibrous matrix of the present invention may comprise wettable natural fibers having a fiber-bed friction angle of about 25 degrees or greater upon wetting. The fibers and/or fibrous matrix may be included into an absorbent composite further comprising a water swellable, water insoluble superabsorbent material. The fibers and/or fibrous matrix has a dry fiber-bed fiber-bed cohesion value and a wet fiber-bed cohesion value wherein the wet fiber-bed cohesion value may be about 120% of the dry fiber-bed cohesion value or greater.

These and other features, aspects, and advantages of the present invention will become better understood with regard to the following description, appended claims, and accompanying drawings.

### BRIEF DESCRIPTION OF DRAWINGS OF EXAMPLES AND/OR REPRESENTATIVE EMBODIMENTS

FIG. 1 shows an example of a response of a porous medium to a stress (i.e., a force per unit area) acting on the medium.

FIG. 2 shows an example of the state of stress of an arbitrary element at equilibrium in a porous medium.

FIG. 3 shows an example of an arbitrary element and the normal forces and shear forces acting on a plane passing through the arbitrary element.

FIG. 4 shows an example of a Mohr Circle on a plot of shear stress (y axis) versus normal stress (x axis).

FIG. 5 shows an example of a sequence of Mohr Circles corresponding to one possible stress path on a plot of shear stress (y axis) versus normal stress (x axis).

FIG. 6 shows an example of Mohr Circles in relation to a Mohr-Coulomb failure envelope on a plot of shear stress (y axis) versus normal stress (x axis).

FIG. 7 shows another example of Mohr Circles in relation to a Mohr-Coulomb failure envelope on a plot of shear stress (y axis) versus normal stress (x axis).

FIG. 8 shows an example of a friction-angle measuring device, in this case a Jenike-Schulze ring-shear tester, available in the U.S. from Jenike-Johanson, a business having offices in Wesfford, Mass.

### DEFINITIONS

Within the context of this specification, each term or phrase below will include the following meaning or meanings.

“Absorbency Under Load” (AUL) refers to the measure of the liquid retention capacity of a material under mechanical load. It is determined by a test which measures the amount, in grams, of a 0.9% by weight aqueous sodium chloride solution a gram of material may absorb in 1 hour under an applied load or restraining pressure of about 0.3 pound per square inch (2,000 Pascals). A procedure for determining AUL is provided in U.S. Pat. No. 5,601,542, which is incorporated by reference in its entirety in a manner consistent herewith.

“Absorbent article” includes, without limitation, diapers, training pants, swim wear, absorbent underpants, baby wipes, incontinence products, feminine hygiene products and medical absorbent products (for example, absorbent medical garments, underpads, bandages, drapes, and medical wipes).

“Fiber” and “Fibrous Matrix” includes, but is not limited to natural fibers, synthetic fibers and combinations thereof. Examples of natural fibers include cellulosic fibers (e.g., wood pulp fibers), cotton fibers, wool fibers, silk fibers and the like, as well as combinations thereof. Synthetic fibers can include rayon fibers, glass fibers, polyolefin fibers, polyester fibers, polyamide fibers, polypropylene. As used herein, it is understood that the term “fibrous matrix” includes a plurality of fibers.

“Free Swell Capacity” refers to the result of a test which measures the amount in grams of an aqueous 0.9% by weight sodium chloride solution that a gram of material may absorb in 1 hour under negligible applied load.

“Fiber-bed friction angle” refers to the friction angle of a fiber or fiber material in a fiber bed as measured with a Jenike-Shulze ring shear tester or other friction angle measuring technique. Unless otherwise specified, the determination is done with wetted fiber. For purposes of this application, the fiber is considered to be wetted when the fiber is brought to a saturation level, with 0.9% sodium chloride solution (sodium chloride dissolved in distilled water), which corresponds to about 0.2 grams or more of 0.9% sodium chloride solution per gram of oven-dry fiber. The oven-dry weight of fiber is determined by placing a small quantity of fiber in an oven at 105 degrees Celsius for 2-4 hours. The dried fiber is placed in a dessicator with a dessicant until it is cool. The fiber is then weighed. For purposes of this application, the fiber is considered to be dry when the fiber is below 0.2 grams of moisture per grams of dry fibers.

For purposes of this application, “Cohesion,” “effective cohesion,” and “cohesion value” refers to cohesion of a fiber or fiber material in a fiber bed as measured with a Jenike-Shulze ring shear tester or other measuring technique. Unless otherwise specified, the determination is done with wetted fiber. For purposes of this application, the fiber is considered to be wetted when the fiber is brought to a saturation level, with 0.9% sodium chloride solution (sodium chloride dissolved in distilled water), which corresponds to about 0.5 grams or more of 0.9% sodium chloride solution per gram of oven-dry fiber. The oven-dry weight of fiber is determined by placing a small quantity of fiber in an oven at 105 degrees Celsius for 2-4 hours. The dried fiber is placed in a dessicator with a dessicant until it is cool. The fiber is then weighed.

“Gradient” refers to a graded change in the magnitude of a physical quantity, such as the quantity of superabsorbent material present in various locations of an absorbent pad, or other pad characteristics such as mass, density, or the like.

“Fiber bed” or “fiber-bed” refers to an amount of fiber within a container such as a ring shear cell.

“High yield pulp fibers” are those papermaking fibers produced by pulping processes providing a yield of about 65 percent or greater, more specifically about 75 percent or greater, and still more specifically from about 75 to about 95 percent. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulphite pulps, and high yield kraft pulps, all of which leave the resulting fibers with high levels of lignin. Suitable high-yield pulp fibers are characterized by being comprised of comparatively whole, relatively undamaged tracheids, high freeness (over 250 CSF), and low fines content (less than 25 percent by the Britt jar test).

“Homogeneously mixed” refers to the uniform mixing of two or more substances within a composition, such that the magnitude of a physical quantity of each of the substances remains substantially consistent throughout the composition.

“Incontinence products” includes, without limitation, absorbent underwear for children, absorbent garments for children or young adults with special needs such as autistic children or others with bladder/bowel control problems as a result of physical disabilities, as well as absorbent garments for incontinent older adults.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are suitably substantially continuous in length.

“Mohr circle” refers to a graphical representation of the state of stress within a material subjected to one or more forces. Mohr circles are described in more detail below.

“Mohr failure envelope” refers to the failure shear stress at the failure plane as a function of the normal stress on that failure or shear plane. Mohr failure envelopes are described in more detail below.

“Polymers” include, but are not limited to, homopolymers, copolymers, such as for example, block, graft, random and alternating copolymers, terpolymers, etc. and blends and modifications thereof. Furthermore, unless otherwise specifically limited, the term

“polymer” shall include all possible geometrical configurations of the material. These configurations include, but are not limited to isotactic, syndiotactic and atactic symmetries.

“Superabsorbent” or “superabsorbent material” refers to a water-swellable, water-insoluble organic or inorganic material capable, under the most favorable conditions, of absorbing at least about 10 times its weight and, more particularly, at least about 20 times its weight in an aqueous solution containing 0.9 weight percent sodium chloride. The superabsorbent materials may be natural, synthetic and modified natural polymers and materials. In addition, the superabsorbent materials may be inorganic materials, such as silica gels, or organic compounds such as cross-linked polymers. The superabsorbent materials of the present invention may embody various structure configurations including particles, fibers, flakes, and spheres.

“Spunbonded fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartmann; U.S. Pat. No. 3,502,538 to Petersen; and, U.S. Pat. No. 3,542,615 to Dobo et al., each of which is incorporated by reference in its entirety in a manner consistent herewith. Spunbond fibers are quenched and generally not tacky when they are deposited onto a collecting surface. Spunbond fibers are generally continuous and often have average deniers larger than about 0.3, more particularly, between about 0.6 and 10.

These terms may be defined with additional language in the remaining portions of the specification.

Overview of Continuum Mechanics, Mohr Circles, and Mohr-Coulomb Failure Theory

Given that our discovery is described using tools and terminology from mechanics, an overview of continuum mechanics, Mohr circles, and Mohr-Coulomb failure theory is provided for convenience. It should be understood that this overview is for purposes of explanation only—it provides an analytic framework for characterizing the present invention, and should not be viewed as limiting the present invention disclosed herein.

Absorbent articles and composites are porous by nature. The open space between the various ingredients that make up the composite (e.g., superabsorbent material and fibers) is commonly referred to as void space or pore space. Pore space acts to store liquids and/or provide a conduit or pathway for transporting liquid throughout the absorbent composite or article. The volume of pore space per unit volume of absorbent composite is commonly referred to as “porosity.” Generally absorbency performance is improved by increasing porosity. For example, permeability of an absorbent composite—i.e., the ability of the composite to facilitate liquid transport—increases with increasing porosity (other factors, such as specific surface area and tortuosity, being equal).

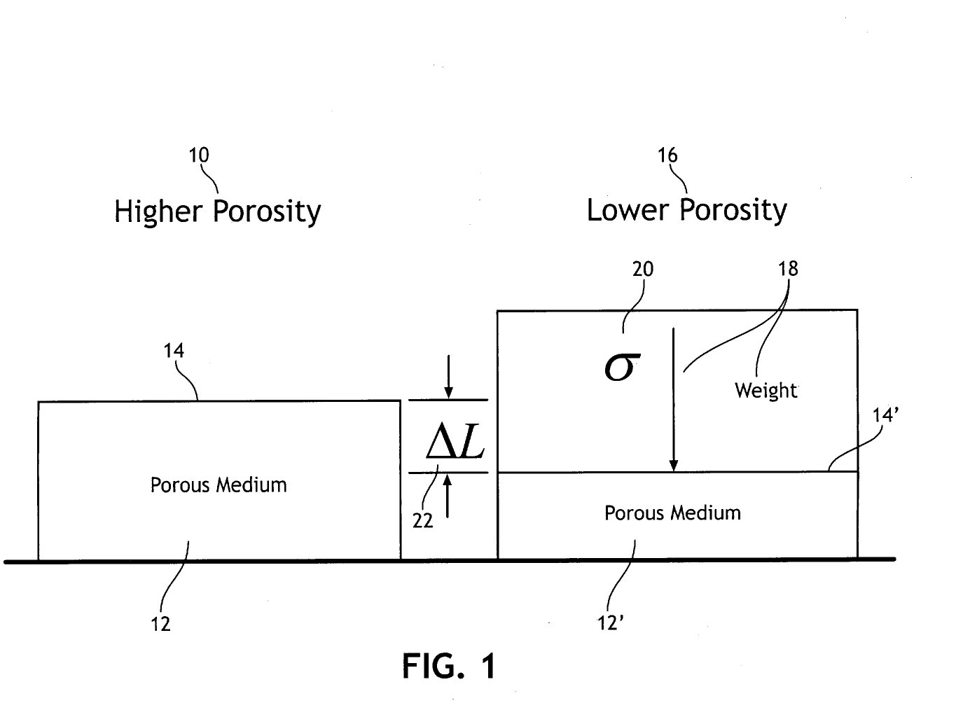

The application of a stress to a porous medium, such as an absorbent composite or article, is known to cause a volumetric deformation of the medium as a whole, as well as shear deformation in the case of anisotropic stresses. FIG. 1 depicts an example of a volumetric deformation of a porous medium. The left-most image of FIG. 1 is labeled “Higher Porosity” 10 and shows a porous medium 12 without a weight applied to the uppermost planar surface 14 of the porous medium 12 (with the uppermost planar area having some discrete area). The right-most image of FIG. 1 is labeled “Lower Porosity” 16 and shows the same porous medium 12′ with a weight 18 applied to the uppermost planar surface 14′ of the porous medium 12′. In response to the placement of the weight 18, which produces a stress, or normal force per unit area, σ 20, the thickness decreases (as denoted by Δ L 22). (Note: for purposes of the present invention, compressive stresses are represented as having positive values.)

For a porous medium 12 made up of individual ingredients such as superabsorbent particles and fibers (e.g., an absorbent composite), the thickness change of the porous medium 12 as a whole, Δ L 22, likely does not result from a reduction in the individual dimensions of individual particles and fibers (reductions in these individual thicknesses would likely be small or negligible). Instead, the decrease in the thickness of the porous medium 12 as a whole, Δ L 22, results from a reduction in porosity (or, analogously, void volume). Accordingly, in the example depicted in FIG. 1, an increase in stress, or normal force per unit area, σ 20, reduces the thickness Δ L 22 of the porous medium 12 as a whole, and reduces the porosity of the porous medium 12. (Note: If, in FIG. 1, a fluid in the pores is a compressible gas, then a normal stress acting on the surface of the porous medium 12 would: compress the gas within the pores; or cause a portion of the gas within the pores to exit the porous medium 12; or, some combination thereof. If, in this same FIG. 1, a fluid in the pores is an incompressible liquid, then a normal stress acting on the surface of the porous medium 12 would cause a portion of the liquid to exit the porous medium 12.)

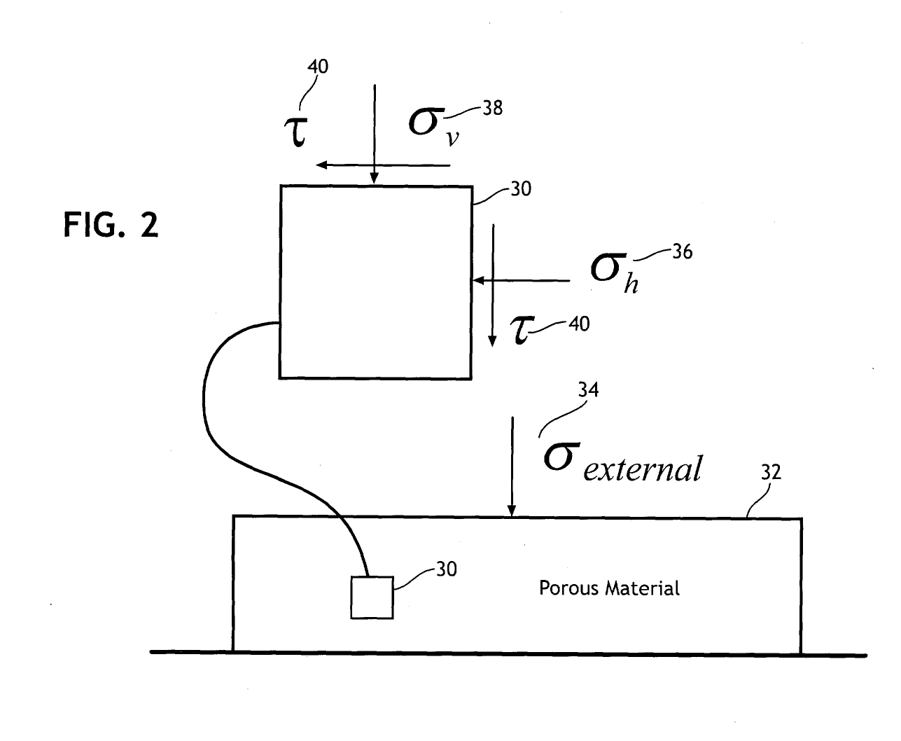

The porous medium 12 of FIG. 1 may be examined further to analyze the stresses acting on an arbitrary element within the porous medium 12. FIG. 2 illustrates the state of stress of an arbitrary element 30—here represented by the face of a cube—at equilibrium (the arbitrary element 30 is within a porous medium 32 being subjected to an external stress σₑₓₜₑᵣₙₐₗ 34). For present purposes, the arbitrary element 30 within the porous medium 32 is treated as a continuum. In FIG. 2, the state of stress is represented by two normal components of stress, σₕ 36 acting horizontally on a face of the cube and σᵥ 38 acting vertically on another face of the cube, as well as a shear stress τ 40. The normal components of stress 36 are perpendicular to the faces of the arbitrary element 30, whereas the shear stresses 40 are parallel to the faces of the arbitrary element 30.

It should be noted that if the shear stresses 40 are zero (i.e., τ=0), then the two normal stresses 36 are referred to as principal stresses. Furthermore, when τ=0, then the larger of the two normal stresses 36 is called the major principal stress while the other is called the minor principal stress. For the present discussion, the two stresses are assumed to be principal stresses, with σₕ≧σᵥ.

There are generally at least two contributions to stress generation that combine to produce principal stresses such as those identified in FIG. 2. The first is an external stress 34, possibly non-uniform, acting on the boundary of the porous medium 32. This stress is transmitted throughout the porous medium 32 in accordance with well known force-balance equations. The second contribution arises due to swelling of components that make up the porous medium 32 (e.g., a superabsorbent material). For example, the swelling of blocks, or elements, immediately adjacent to the arbitrary element 30 depicted in FIG. 2, may cause an “internally” generated stress acting on or along the arbitrary element 30 as other elements attempt to expand against it and each other.

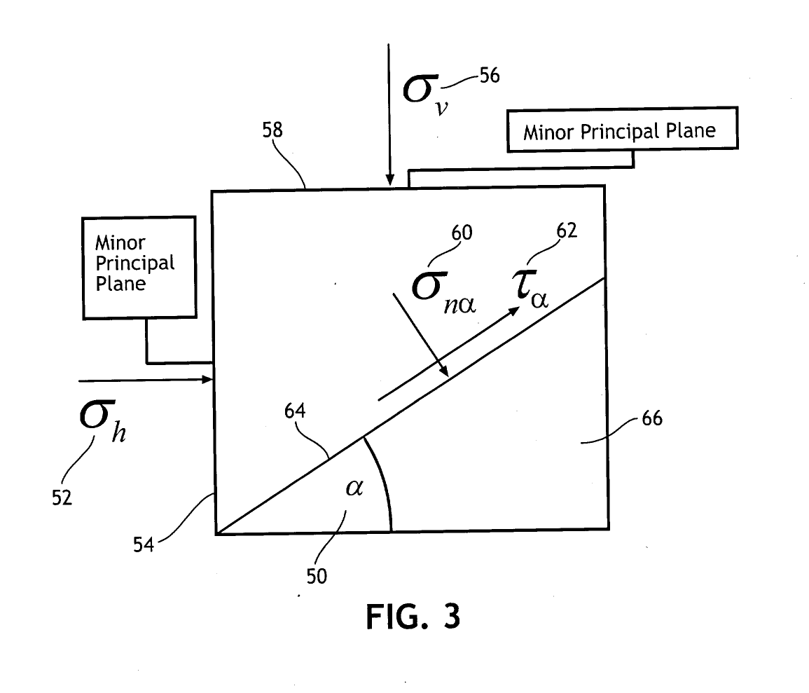

As stated above, when the stresses acting on an arbitrary element 30, such as that depicted in FIG. 2, are principal stresses, there are no shear stresses 40 acting on the faces of the arbitrary element. There is, however, shear stress 40 acting on other imaginary planes passing through the depicted arbitrary element 30—planes oriented at some angle α a 50 away from horizontal, 0<α<90°, as shown in FIG. 3. FIG. 3 depicts a major principal stress σₕ 52 acting on a major principal plane 54, and a minor principal stress σᵥ 56 acting on a minor principal plane 58. A normal stress σ_{nα} 60 and a shear stress τ_{α} 62 act on the imaginary or arbitrary plane 64 oriented at angle α 50 away from horizontal.

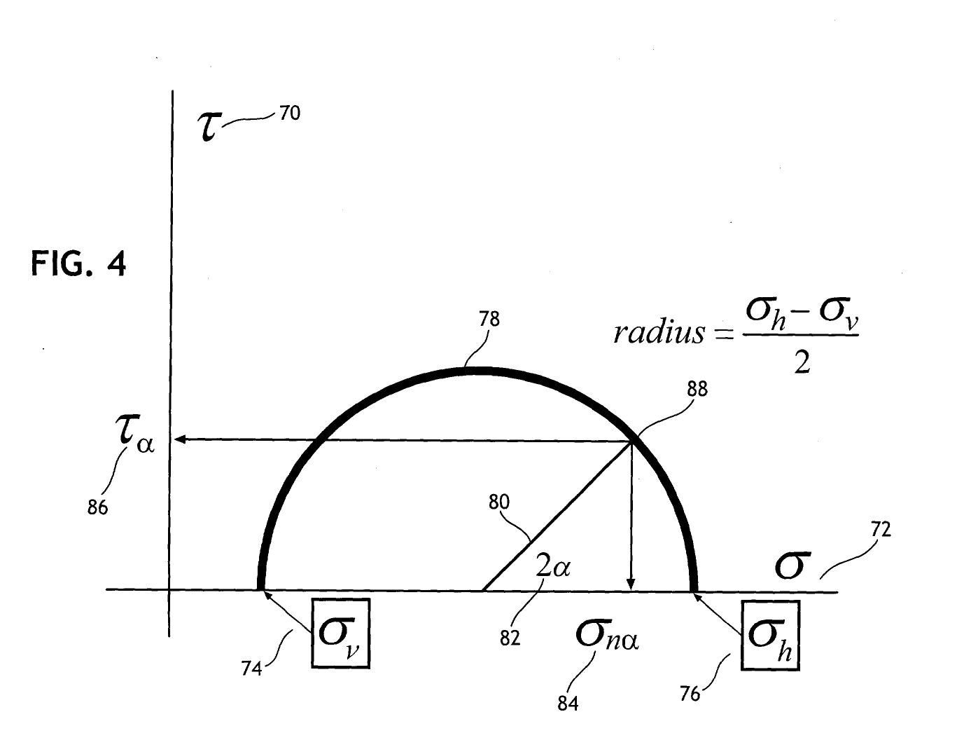

Obtaining the shear and normal forces 62 and 60, respectively, acting on the arbitrary plane 64 passing through the element 66 depicted in FIG. 3 is simplified by using the graphical approach of the Mohr circle, as illustrated in FIG. 4. FIG. 4 shows a plot of shear stress (y-axis) 70 as a function of normal stress (x-axis) 72. For purposes of the present discussion the principal stresses are assumed to be known (e.g., by calculation or measurement). The x-y coordinates of the minor principal stress σᵥ 74 and the major principal stress σₕ 76 lie on the x-axis (i.e., where the shear stress τ 70 is equal to zero). A Mohr semi-circle 78 is drawn such that the coordinates of the minor and major principal stresses 74 and 76, respectively, correspond to the end points of the arc defining the perimeter of the Mohr semi-circle 78. The radius of the Mohr semi-circle 78 equals one-half of the difference between the major principal stress σₕ 76 and the minor principal stress σᵥ 74. By constructing a radial line segment 80 at an angle 2α 82 from the x-axis, with one end of the radial line segment 80 corresponding to the center of the Mohr semi-circle 78, and other end corresponding to a point on the semi-circle arc closest to the major principal stress, both the normal stress, σ_{nα} 84, and the shear stress τ_{α} 86 are obtained at the intersection 88 of the radial line segment 80 with the Mohr semi-circle 78.

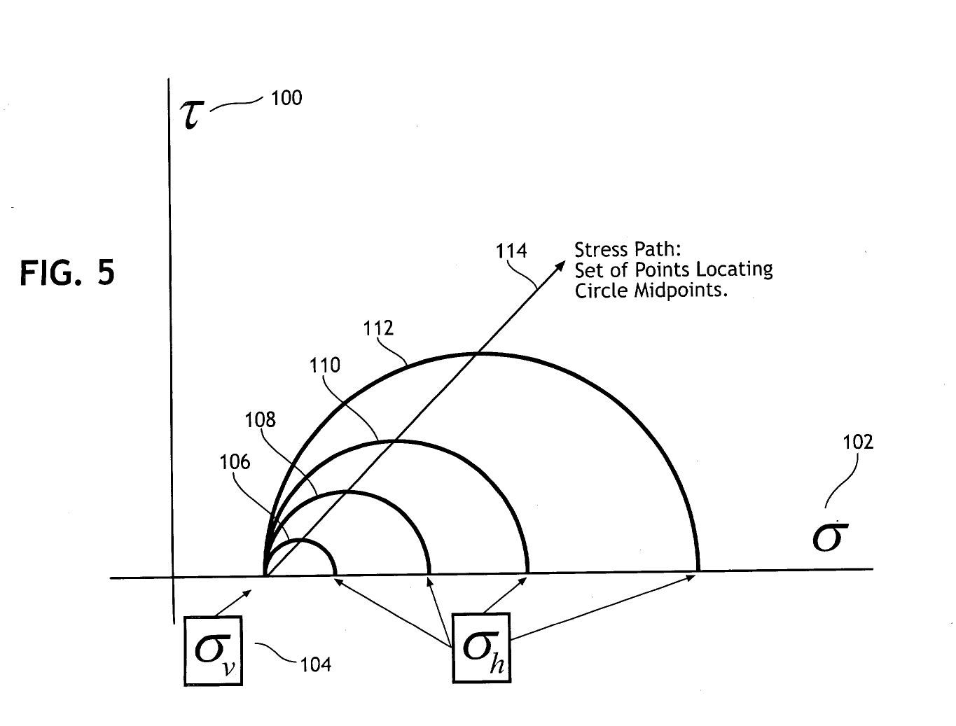

FIG. 5 depicts one example of stress evolution for a porous medium that employs one or more swelling components (e.g., a particulate superabsorbent material). The y-axis again corresponds to shear stress τ 100, and the x-axis again corresponds to normal stress σ 102. If the minor principal stress σᵥ 104 acting on an arbitary element from the porous medium remains unchanged, then stress development (which would accompany, for example, swelling of superabsorbent material) may be viewed as a family of Mohr circles 106, 108, 110, and 112, all of which have the same minor principal stress σᵥ 104. The progression of Mohr circles 106, 108, 110, and 112 is commonly referred to as a stress path 114—more precisely, the line passing through the set of Mohr circles 106, 108, 110, and 112 at points simultaneously locating the maximum shear stress and mean stress for each Mohr circle 106, 108, 110, and 112.

The center of each Mohr circle 106, 108, 110, and 112, which equates to the mean stress, determines the volumetric deformation of pore space contained within a particular arbitrary element, and may correspond to the approximate stress experienced by superabsorbent materials.

Stresses in a porous medium are not likely to increase indefinitely—rather, failure will take place, accompanied by sliding along particular failure planes (e.g., at the interface between superabsorbent material and fiber; or at the interface between individual particles of superabsorbent material; etc.). The Mohr-Coulomb failure criterion states that a shear force acting on a plane at failure will be linearly proportional to the normal force acting on that same plane, again at failure. Hence, Mohr-Coulomb theory provides a failure limit, or envelope, beyond which stable states of stress do not exist. If a line corresponding to this failure limit is superimposed on a plot of shear stress and normal stress depicting a Mohr circle 106, 108, 110, or 112 (which may be thought of as corresponding to a given state or degree of swelling for a porous medium employing a superabsorbent material), then the Mohr circle 106, 108, 110, or 112 may only increase in radius (e.g., by additional swelling of the porous medium and/or superabsorbent material employed by the porous medium) to the extent that it becomes tangent to this linear envelope. It should be noted that the failure envelope may be determined empirically using a tester, such as the Jenike-Schulz ring-shear tester, by determining the shear stress at failure for a given normal stress acting on a bed of material (e.g., a fiber bed; or a gel bed of superabsorbent material). By plotting a number of shear stresses at failure for a number of different normal stresses, the Mohr-Columb failure envelope (or line or limit) may be determined.

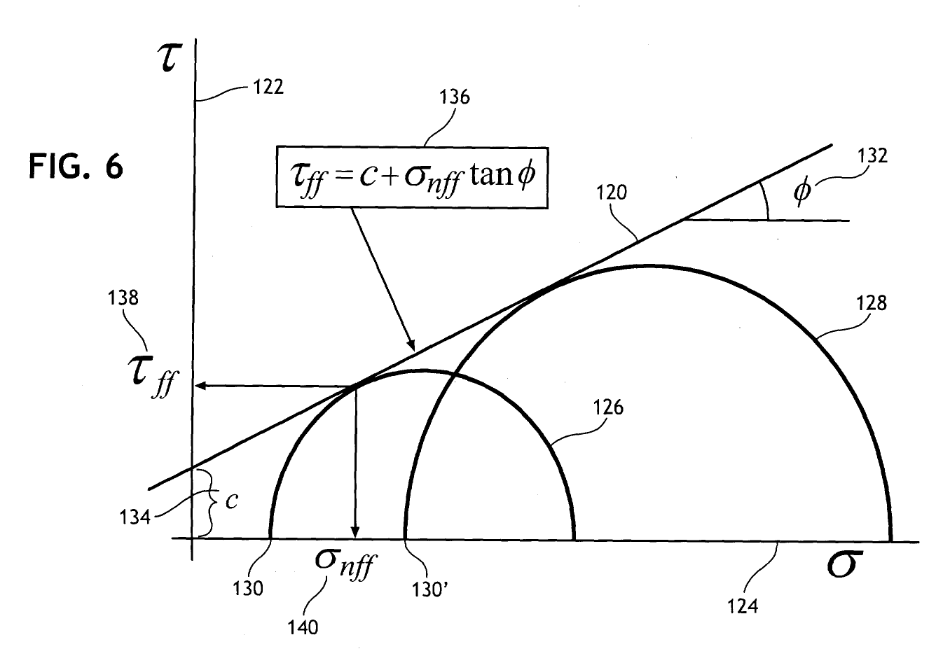

FIG. 6 depicts a linear failure envelope 120 on a plot of shear stress τ 122 versus normal stress σ 124. On this plot are depicted two Mohr circles 126 and 128, with each Mohr circle having a different value of initial stress—that is, two different values of the minor principal stress σᵥ 130 and 130′. The friction angle φ 132 and cohesion c 134 are properties of a particular material (e.g., an absorbent composite comprising fiber and superabsorbent material; a gel bed of swollen, particulate superabsorbent material; etc.). The tangent of the friction angle φ 132, which is equivalent to the coefficient of static friction from elementary physics, measures the extent to which an increasing normal force permits a larger maximum shear stress. Cohesion c 134 represents the amount of shear stress a material will tolerate before failure in the absence of any normal force on the proposed failure plane. An increase in any one of the three parameters—friction angle φ 132, cohesion c 134, or minor principle stress σᵥ 130 and 130′—will permit the development of larger stresses in a porous material—i.e., a larger Mohr circle. Friction angle φ 132 and cohesion c 134 are material dependent and may be measured (e.g., using the test and methodology disclosed herein). FIG. 6 also depicts the mathematical relationship τ_{ff}=c+σ_{nff}(tan φ) 136, which relates friction angle φ 132, cohesion c 134, shear stress at failure τ_{ff} 138, and normal stress at failure σ_{nff} 140. (Note: for purposes of this disclosure, σ_{nff} is equivalent to σ_{ff}, with both terms referring to a normal stress acting on a failure plane at failure.) This relationship is described in more detail below in the Detailed Description section.

As stated earlier, it is generally advantageous to minimize or decrease the reduction of porosity, or void volume, which results from the application of a compressive stress to an absorbent article. By choosing materials that limit stress increases (e.g., fiber having controlled fiber-bed friction angle; or fiber having low cohesion values) the magnitude of porosity reductions may be decreased. For example, low, controlled fiber-bed friction angle fiber will promote the onset of failure before stresses rise to values that cause significant losses of porosity, and therefore permeability. An additional benefit of providing stress relief through low, controlled fiber-bed friction angle fiber is that any superabsorbent materials employed with the fiber in a composite will retain a larger portion of their free-swell capacity—since it is well known that superabsorbent capacity decreases with increasing loading. It should be noted, however, that in some contexts—e.g., an absorbent composite having a high porosity—it may be advantageous to employ a fiber having a high, controlled fiber-bed friction angle and/or cohesion value, thereby “locking in” the high porosity.

### DETAILED DESCRIPTION OF REPRESENTATIVE EMBODIMENTS

The present invention relates to fiber and the use of the fiber in absorbent composites of absorbent articles. The present invention encompasses employing fiber described in this application alone, or with other ingredients, including superabsorbent materials. Examples of suitable superabsorbents are described in co-pending applications designated under U.S. Provisional Patent Application Serial No. 60/399877, entitled “Superabsorbent Materials Having Low, Controlled Gel-Bed Friction Angles and Composites Made From The Same,” filed on 30 Jul. 2002; and U.S. Provisional Patent Application Serial No. 60/399794, entitled “Superabsorbent Materials Having High, Controlled Gel-Bed Friction Angles and Composites Made From The Same,” also filed on 30 Jul. 2002. As stated above, both of these co-pending applications are incorporated by reference in their entirety in a manner consistent herewith. Conventional superabsorbents may also be employed with fiber of the present invention.

Absorbent composites of absorbent articles typically contain superabsorbent material, in relatively high quantities in some cases, in various forms such as superabsorbent fibers and/or superabsorbent particles, homogeneously mixed with a matrix material, such as cellulose fluff pulp. The mixture of superabsorbent material and cellulose fluff pulp may be homogeneous throughout the absorbent composite or the superabsorbent material may be strategically located within the absorbent composite, such as forming a gradient within the fiber matrix. For example, more superabsorbent material may be present at one end of the absorbent composite than at an opposite end of the absorbent composite. Alternatively, more superabsorbent material may be present along a top surface of the absorbent composite than along a bottom surface of the absorbent composite or more superabsorbent material may be present along the bottom surface of the absorbent composite than along the top surface of the absorbent composite. One skilled in the art will appreciate the various embodiments available for absorbent composites. The fiber materials of the present invention may be used in these and other various embodiments of absorbent composites (optionally including one or more novel superabsorbent described in the co-pending applications identified above).

Absorbent composites comprising a superabsorbent material typically include a matrix which contains the superabsorbent material. The matrix is often made from a fibrous material or foam material, but one skilled in the art will appreciate the various embodiments of the composite matrix. One such fibrous matrix is made of a cellulose fluff pulp. The cellulose fluff pulp suitably includes wood pulp fluff. The cellulose pulp fluff may be exchanged, in whole or in part, with synthetic, polymeric fibers (e.g., meltblown fibers). Synthetic fibers are not required in the absorbent composites of the present invention, but may be included. One preferred type of wood pulp fluff is identified with the trade designation CR1654, available from Bowater, Childersburg, Ala., U.S.A., and is a bleached, highly absorbent wood pulp containing primarily soft wood fibers. The cellulose fluff pulp may be homogeneously mixed with the superabsorbent material. Within the absorbent article, the homogeneously mixed fluff and superabsorbent material may be selectively placed into desired zones of higher concentration to better contain and absorb body exudates. For example, the mass of the homogeneously mixed fluff and superabsorbent materials may be controllably positioned such that more basis weight is present in a front portion of the pad than in a back portion of the pad.

Absorbent composites of the present invention may suitably contain between about 5 to about 95 mass % of superabsorbent material, based on the total weight of the fiber, the superabsorbent material, and/or any other component. Optionally, the mass composition of the superabsorbent material in the absorbent composite may be from about 20 to about 80%. Additionally, the mass composition of the superabsorbent material in the absorbent composite may be from about 40 to about 60%.

Suitable superabsorbent materials that may be employed with fiber of the present invention may be selected from natural, synthetic, and modified natural polymers and materials. The superabsorbent materials may be inorganic materials, such as silica gels, or organic compounds, including natural materials such as agar, pectin, guar gum, and the like, as well as synthetic materials, such as synthetic hydrogel polymers. Such hydrogel polymers include, for example, alkali metal salts of polyacrylic acids; polyacrylamides; polyvinyl alcohol; ethylene maleic anhydride copolymers; polyvinyl ethers; hydroxypropylcellulose; polyvinyl morpholinone; polymers and copolymers of vinyl sulfonic acid, polyacrylates, polyacrylamides, polyvinyl pyridine; polyamines; and, combinations thereof. Other suitable polymers include hydrolyzed acrylonitrile grafted starch, acrylic acid grafted starch, and isobutylene maleic anhydride copolymers, and combinations thereof. The hydrogel polymers are suitably lightly crosslinked to render the material substantially water-insoluble. Crosslinking may, for example, be by irradiation or by covalent, ionic, Van der Waals, or hydrogen bonding. The superabsorbent materials may be in any form suitable for use in absorbent structures, including, particles, fibers, flakes, spheres, and the like.

Typically, a superabsorbent polymer is capable of absorbing at least about 10 times its weight in a 0.9 weight percent aqueous sodium chloride solution, and particularly is capable of absorbing more than about 20 times its weight in 0.9 weight percent aqueous sodium chloride solution. Superabsorbent polymers are available from various commercial vendors, such as Dow Chemical Company located in Midland, Mich., U.S.A., and Stockhausen Inc., Greensboro, N.C., USA. Other superabsorbent polymers are described in U.S. Pat. No. 5,601,542 issued Feb. 11, 1997, to Melius et al.; U.S. patent application Ser. No. 09/475,829 filed in December 1999 and assigned to Kimberly-Clark Corporation; and, U.S. patent application Ser. No. 09/475,830 filed in December 1999 and assigned to Kimberly-Clark Corporation, each of which is hereby incorporated by reference in a manner consistent herewith.

Other examples of commercial superabsorbent materials polyacrylate materials available from Stockhausen under the tradename FAVOR®. Examples include FAVOR® SXM 77, FAVOR® SXM 880, and FAVOR® SXM 9543. Other polyacrylate superabsorbent materials are available from Dow Chemical, USA under the tradename DRYTECH®, such as DRYTECH® 2035.

Superabsorbent materials may be in the form of particles which, in the unswollen state, have maximum cross-sectional diameters typically within the range of from about 50 microns to about 1,000 microns, suitably within the range of from about 100 microns to about 800 microns, as determined by sieve analysis according to American Society for Testing Materials (ASTM) Test Method D-1921. It is understood that the particles of superabsorbent material, falling within the ranges described above, may include solid particles, porous particles, or may be agglomerated particles including many smaller particles agglomerated into particles within the described size ranges.

Fibers suitable to be treated and/or modified for use in the present invention (e.g., to be treated or modified so that they have recited fiber-bed friction values and/or recited fiber-bed cohesion values and/or recited ratios of properties) are known to those skilled in the art. Examples of fibers suitable for use in the present invention include, cellulosic fibers such as wood pulp, cotton linters, cotton fibers and the like; synthetic polymeric fibers such as polyolefin fibers, polyamide fibers, polyester fibers, polyvinyl alcohol fibers, polyvinyl acetate fibers, synthetic polyolefin wood pulp fibers, and the like; as well as regenerated cellulose fibers such as rayon and cellulose acetate microfibers. Mixtures of various fiber types are also suitable for use. For example, a mixture of cellulosic fibers and synthetic polymeric fibers may be used. As a general rule, the fibers will have a length-to-diameter ratio of at least about 2:1, suitably of at least about 5:1. As used herein, “diameter” refers to a true diameter if generally circular fibers are used or to a maximum transverse cross-sectional dimension if non-circular, e.g., ribbon-like, fibers are used. The fibers will generally have a length of from about 0.5 millimeter to about 25 millimeters, suitably from about 1 millimeter to about 6 millimeters. Alternatively, fiber may be continuous or semi-continuous, such as meltblown, spunbond or similar materials. Fiber diameters will generally be from about 0.001 millimeter to about 1.0 millimeter, suitably from about 0.005 millimeter to about 0.05 millimeter. For reasons such as economy, availability, physical properties, and ease of handling, cellulosic wood pulp fibers are suitable for use in the present invention.

Other fibers useful for purposes of the present invention are resilient fibers that include high-yield pulp fibers (further discussed below), flax, milkweed, abaca, hemp, cotton, or any of the like that are naturally resilient or any wood pulp fibers that are chemically or physically modified, e.g. crosslinked or curled, that have the capability to recover after deformation from preparing the absorbent composite, as opposed to non-resilient fibers which remain deformed and do not recover after preparing the absorbent composite.

Absorbent composites may also contain any of a variety of chemical additives or treatments, fillers or other additives, such as clay, zeolites and/or other odor-absorbing material, for example activated carbon carrier particles or active particles such as zeolites and activated carbon. Absorbent composites may also include binding agents, such as crosslinkable binding agents or adhesives, and/or binder fibers, such as bicomponent fibers. Absorbent composites may or may not be wrapped or encompassed by a suitable tissue wrap that maintains the integrity and/or shape of the absorbent composite.

The structure and components of absorbent composites are designed to take up fluids and absorb them. The porosity of the fiber matrix allows fluid to penetrate the absorbent composite. When the absorbent composite includes superabsorbent material, the fiber matrix facilitates penetration of fluid into the absorbent composite and in contact with superabsorbent material, which absorbs the fluids. The superabsorbent material swells as the superabsorbent material absorbs fluids. The swelling of the superabsorbent material may be influenced by the external factors such as surrounding matrix material and pressures (i.e., a force per unit area, or stress) from the absorbent article user. The surrounding matrix fibers and/or superabsorbent materials and the pressures on the superabsorbent material may inhibit the swelling of the superabsorbent material, thus stopping absorbency, and thereby the absorbent composite, from reaching full free swell capacity. Also, as described above, stresses acting on an absorbent composite, such as an absorbent composite employing a superabsorbent material, may reduce porosity and/or permeability of the absorbent composite.

To the extent possible during swelling, superabsorbent materials may move within the composite matrix to positions that allow the superabsorbent to obtain greater swelling. Superabsorbent materials may rotate and/or translate so as to fit within voids in the composite matrix which allows the absorbent particle to swell readily against surrounding matrix and reach greater swelling potentials. Moreover, additional voids/void space may be created by overall expansion of the absorbent composite. Upon moving within the fiber matrix, the superabsorbent materials will contact and rub against other components of the absorbent composite, including matrix fibers and/or other superabsorbent materials. The surface mechanics of the superabsorbent material and the surrounding matrix components may determine the amount of superabsorbent material structure rotation and/or translation and thus may affect: (1) the swelling capacity of the superabsorbent material, and therefore the absorbent composite; and, (2) the level of stress buildup in an absorbent composite employing the superabsorbent, which in turn affects the porosity and permeability of the absorbent composite.

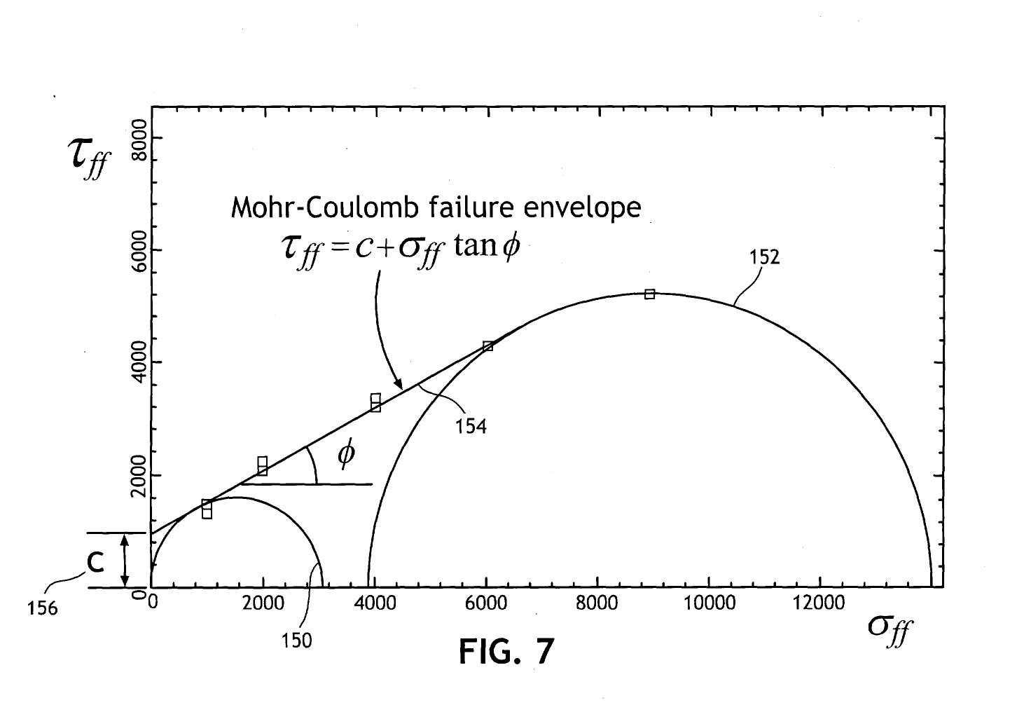

The friction angle and cohesion value of fiber are important mechanical properties that may affect the ability of the superabsorbent material to move or expand within the absorbent composite matrix. As discussed above in the Overview section, friction angle and cohesion comes from Mohr-Coulomb failure theory, and the tangent of the friction angle is equivalent to the traditional coefficient of static friction. A smaller friction angle may indicate less contact friction between the superabsorbent material and the surrounding matrix, and a greater ability for the superabsorbent material to rearrange, within the matrix during swelling so that the superabsorbent material may retain a greater portion of the free swell absorbent capacity. Also, a smaller friction angle may promote failure (i.e., movement between, for example, swollen particles of superabsorbent material; or movement between a swollen particle of superabsorbent material and the surrounding fiber matrix; or movement between individual fibers in contact with one another; etc.) at lower levels of stress buildup, thereby reducing losses in porosity and/or permeability in an absorbent composite. Cohesion equates to the shear stress at failure at a zero applied normal stress. A lower cohesion value may also promote failure as described above. In effect, a lower cohesion value means that the Mohr-Coulomb failure line is shifted downward on a plot of shear stress versus normal stress (such as those depicted in FIGS. 6 and 7).

The state of failure between the surfaces of the superabsorbent material and the surrounding components (e.g., fiber) allows the superabsorbent material to rearrange within the wet matrix or a partially swollen gel-bed. As indicated in the Overview Section, Mohr circles may be used to describe the state of stress of a material, such as a dry or wet fiber bed or absorbent composite or porous medium. FIG. 7 shows representative Mohr circles 150 and 152 for a typical fiber bed (wet or dry). The larger Mohr circle 152 represents a situation where some pre-consolidation stress is imposed on the fiber bed, and the smaller Mohr circle 150 represents the situation where some major principal stress exists anywhere in the fiber bed while the minor principle stress is zero. Although not shown in FIG. 7, Mohr circles are produced at each applied normal stress. The state of failure for a fiber bed (wet or dry) is described by the set of Mohr circles at failure which together define a Mohr failure envelope. The Mohr failure envelope is often very close to linear, shown in FIG. 7 as line 154, and represents the shear stress at failure, on the failure plane, versus the normal stress acting on the same plane. The linearized failure envelope 154, often referred to as the Mohr-Coulomb failure criterion, may be represented mathematically by the formula:

τ_{ff}=c+σ_{ff}(tan φ)

where τ_{ff} is shear stress, c is the effective cohesion constant, σ_{.ff} is normal stress, and φ is the friction angle of the fiber bed or fiber. The effective cohesion constant is represented on the graph by value 156 and pertains to the cohesion of the fiber.

The fiber-bed friction angle and effective cohesion constant (or cohesion value) of fiber of the present invention may be determined using various methods used in fields such as soil mechanics. Useful instruments for determining gel-bed friction angle include triaxial shear measurement instruments, such as a Sigma-1, available from GeoTac, Houston, Tex., or ring shear testers such as the Jenike-Shulze Ring Shear Tester, available from Jenike & Johanson, Inc., Westford, Mass.

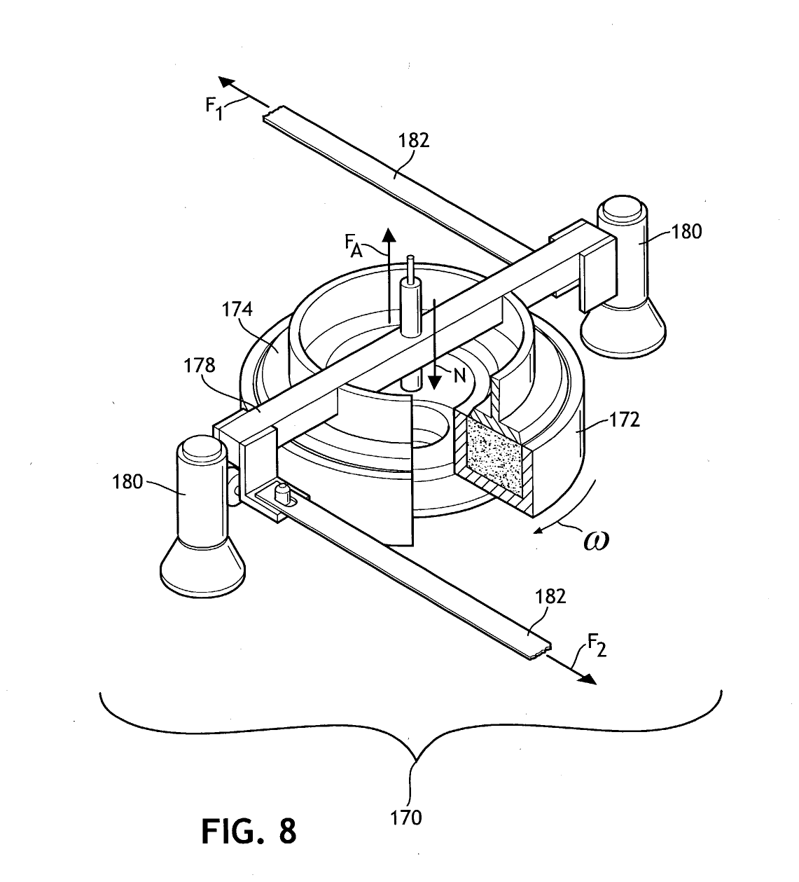

FIG. 8 shows a partial cut-away schematic of a Jenike-Shulze Ring Shear Tester, designated as reference numeral 170. The ring shear tester 170 has a ring shear cell 172 connected to a motor (not shown) that may rotate the ring shear cell 172 in direction ω. The ring shear cell 172 and lid 174 contain the fiber bed 176 to be tested. The lid 174 is not fixed to the ring shear cell 172 and the crossbeam 178 crosses the lid 174 and connects two guiding rollers 180 and two tie rods 182 to lid 174. For measuring the fiber bed of wet fiber 176 the fiber is wetted outside the ring shear cell 172 and placed in the ring shear cell 172. Of course this step is omitted when the friction angle and cohesion of a dry fiber bed is being determined (Note: “dry” does not mean that all water is absent from the fiber; some water will be present, even in dry fiber, at ambient conditions—e.g., about 2 to about 5% moisture based on the oven-dry weight of the fiber. Oven-dry weight of fiber typically refers to the weight of fiber after the fiber has been dried in an oven at 105 degrees Celsius.) A predetermined force N may be placed upon the lid 174, and therefore on the fiber bed 176, by a weight (not shown). A counterweight system (not shown) may be engaged to test at lower normal pressure. As the ring shear cell 172 rotates in direction ω by the computer controlled motor (not shown), a shear force is placed on the fiber bed 176 contacting the ring shear cell 172. An instrument connected to the tie rods 182 measures the forces F1 and F2, which are used to determine the shear stress at failure (for the given applied normal stress at which the test is conducted) of the fiber bed 176 (i.e., the fiber). The cohesion value corresponds to the shear stress at failure for an applied normal stress of zero.

Fiber having a low fiber-bed friction angle may be useful in absorbent composites. In one embodiment of the present invention, the fiber-bed friction angle of natural fiber decreases upon wetting to about 35 degrees or less. More suitably the fiber-bed friction angle of natural fiber decreases upon wetting to about 30 degrees or less. More particularly, the fiber-bed friction angle of natural fiber decreases upon wetting to about 25 degrees or less.

When employed in an absorbent composite, the low fiber-bed friction angle fiber of the present invention reduces the local stresses occurring in the absorbent composite. For example, in an absorbent composite employing both a superabsorbent material and the low fiber-bed friction angle fiber described above, the fiber helps reduce the local stresses between the superabsorbent materials and the surrounding fiber matrix components, which may allow the superabsorbent material structures to rearrange within the voids of an absorbent composite matrix more easily. The low fiber-bed friction angle fibers may allow for the superabsorbent materials to obtain a greater portion of their free swell absorbent capacity. In addition, permeability is generally maintained at suitable values because the development of higher internal stresses is alleviated. As indicated above, the buildup of stresses may result in additional compression of pore space.

In another embodiment of the present invention, the low fiber-bed friction angle fiber described in the two preceding paragraphs is combined with one or more embodiments of a low gel-bed friction-angle superabsorbent material described in U.S. Provisional Patent Application Serial No. 60/399877, entitled “Superabsorbent Materials Having Low, Controlled Gel-Bed Friction Angles and Composites Made From The Same,” filed on 30 Jul. 2002 (as stated above, this co-pending application is incorporated by reference).

Low superabsorbent material gel-bed friction angles may be obtained through non-conventional manufacturing processes that produce superabsorbent material structures possessing low-friction surfaces (e.g., smooth surfaces). Low superabsorbent material gel-bed friction angles may also be obtained by treatment of superabsorbent materials with friction angle reducing additives that decrease friction angle upon becoming wet. Examples of such friction angle reducing additives include, without limitation, glycerol, oils such as mineral oil and silicone oil, oleic acid, polysaccharides, polyethylene oxides.

The amount of fiber-bed friction angle reducing additives, surfactants, or emulsifiers may be about 1.0% by weight of the dry fiber or less. Optionally, the amount of fiber-bed friction angle reducing additives, surfactants, or emulsifiers may be about 10.0% by weight of the dry fiber or less. Additionally, the amount of fiber-bed friction angle reducing additives, surfactants, or emulsifiers may be about 100.0% by weight of the dry fiber or less. The amount of fiber-bed friction angle reducing additives, surfactants, or emulsifiers may be about 0.001% by weight of the dry fiber or greater. Optionally, the amount of fiber-bed friction angle reducing additives, surfactants, or emulsifiers may be about 0.1% by weight of the dry fiber or greater. Additionally, the amount of fiber-bed friction angle reducing additives, surfactants, or emulsifiers may be about 1.0% by weight of the dry fiber or greater.

Small concentrations of emulsifiers and/or surfactants in addition to the additives, and additive mixtures such as a 50/50 by weight mixture of glycerol and mineral oil, may help reduce the fiber-bed friction angle of the fiber. The emulsifiers and surfactants may increase the miscibility between nonpolar additives, such as mineral oil, and polar additives, such as glycerol. The emulsifiers and surfactants may also play an integral role in coating the swollen fiber. Various emulsifiers and/or surfactants may be used in the present invention depending on the additive used. Examples of emulsifiers are phosphatidylcholine and lecithin. Examples of liquid surfactants include sorbitan monolaurate, compounds of the TRITON® series (X-100, X-405 & SP-135) available from J. T. Baker, compounds of the BRIJ® series (92 and 97) available from J. T. Baker, polyoxyethylene (80) sorbitan monolaurate, polyoxyethylene sorbitan tetraoleate, and triethanolamine and other alcohol amines, and combinations thereof. When using mixtures of polar and nonpolar compounds, such as friction angle or cohesion value altering additives, emulsifiers, and surfactants, the nonpolar compound may be present in a larger proportion than the polar compound.

In another embodiment of the present invention, fiber having a high fiber-bed friction angle is useful in an absorbent composite which is in a highly swollen state and/or in a high porosity state. In one embodiment of the present invention, the fiber-bed friction angle of the fiber increases upon wetting to at least about 50 degrees. More suitably, the fiber-bed friction angle of the fiber increases upon wetting to at least about 52 degrees. More particularly, the fiber-bed friction angle of the fiber increases upon wetting to at least about 55 degrees.

When an absorbent composite has high porosity and/or is in a highly swollen state, the high friction angle of the fiber may slow and/or inhibit rearranging within the absorbent composite matrix due to shear failure and/or collapse. Slowing and/or inhibiting the rearrangement of, for example, superabsorbent material may maintain an open composite structure, if desired, thereby maintaining a desirable absorbent composite permeability. High fiber-bed friction angle fiber may be particularly suitable for maintaining highly open structures when a load is subsequently applied. High fiber-bed friction angles may be obtained through manufacturing processes or by treatment of lower friction angle fiber with various additives that increase fiber-bed friction angle of the fiber when wet. In one embodiment of the present invention, the cationic polymer friction angle increasing additive chitosan may create a sticky condition between anionic fiber leading to a higher friction angle. Other examples of such friction angle increasing additives include, without limitation, sodium silicate, sodium aluminate, and alumino silicates.

The amount of fiber-bed friction angle increasing additives, surfactants, or emulsifiers may be about 1.0% by weight of the dry fiber or less. Optionally, the amount of fiber-bed friction angle increasing additives, surfactants, or emulsifiers may be about 10.0% by weight of the dry fiber or less. Additionally, the amount of fiber-bed friction angle increasing additives, surfactants, or emulsifiers may be about 100.0% by weight of the dry fiber or less. The amount of fiber-bed friction angle increasing additives, surfactants, or emulsifiers may be about 0.001% by weight of the dry fiber or greater. Optionally, the amount of fiber-bed friction angle increasing additives, surfactants, or emulsifiers may be about 0.1% by weight of the dry fiber or greater. Additionally, the amount of fiber-bed friction angle increasing additives, surfactants, or emulsifiers may be about 1.0% by weight of the dry fiber or greater.

In another embodiment of the present invention, the high fiber-bed friction angle fiber described in the two preceding paragraphs is combined with one or more embodiments of a high gel-bed friction-angle superabsorbent material described in U.S. Provisional Patent Application Serial No. 60/399794, entitled “Superabsorbent Materials Having High, Controlled Gel-Bed Friction Angles and Composites Made From The Same,” filed on 30 Jul. 2002 (as stated above, this co-pending application is incorporated by reference).

Absorbent composites of the present invention may include various controlled fiber-bed friction angle fibers of the present invention, including fibers having high fiber-bed friction angles and/or fiber having low fiber-bed friction angles. The fiber with controlled fiber-bed friction angles may be homogeneously mixed within the absorbent composite or strategically located within different absorbent composite areas, where the respective controlled fiber-bed friction angles are desired.

Small concentrations of emulsifiers and/or surfactants may be used in addition to the friction angle increasing additives, and friction angle increasing additive mixtures, may help increase the gel-bed friction angle of the superabsorbent materials. The emulsifiers and surfactants may increase the miscibility between nonpolar friction angle increasing additives and polar friction angle increasing additives. The emulsifiers and surfactants may also play an integral role in coating the swollen superabsorbent materials. Various emulsifiers and/or surfactants may be used in the present invention depending on the friction angle increasing additive used. Examples of emulsifiers are phosphatidylcholine and lecithin. Examples of liquid surfactants include sorbitan monolaurate, compounds of the TRITON® series (X-100, X-405 & SP-135) available from J. T. Baker, compounds of the BRIJ® series (92 and 97) available from J. T. Baker, polyoxyethylene (80) sorbitan monolaurate, polyoxyethylene sorbitan tetraoleate, and triethanolamine and other alcohol amines, and combinations thereof.

In another embodiment of the present invention, the wet fiber-bed friction angle is about 80% or less of the dry fiber-bed friction angle of a given fiber (e.g., a natural fiber; a synthetic fiber; or some combination thereof). Suitably, the wet fiber-bed friction angle is about 60% or less of the dry fiber-bed friction angle of a given fiber or fiber blend (e.g., a natural fiber; a synthetic fiber; or some combination thereof). Particularly, the wet fiber-bed friction angle is about 40% or less of the dry fiber-bed friction angle of a given fiber or fiber blend (e.g., a natural fiber; a synthetic fiber; or some combination thereof).

In another embodiment, the wet fiber-bed cohesion value is about 120% or less of the dry fiber-bed cohesion value of a given fiber. Suitably the wet fiber-bed cohesion value is about 100% or less of the dry fiber-bed cohesion value of a given fiber. Particularly the wet fiber-bed cohesion value is about 80% or less of the dry fiber-bed cohesion value of a given fiber. In effect, the lower wet cohesion values, which generally shift a Mohr-Coulomb failure line downward (see, e.g., FIG. 7), correspond to a fiber matrix, or composite employing the matrix, that will allow for any optionally employed superabsorbent materials to obtain a greater portion of their free swell absorbent capacity. In addition, permeability is generally maintained at suitable values because the development of higher internal stresses is alleviated or prevented.

In another embodiment, the wet fiber-bed cohesion value for natural fibers or blends is 5,000 Pascals (Pa) or lower. Suitably, the wet fiber-bed cohesion value for natural fibers or blends is 4,000 Pascals or lower. Particularly, the wet fiber-bed cohesion value for natural fibers or blends is 2,500 Pascals or lower. As stated above, the lower wet cohesion values will allow for any superabsorbent materials optionally employed with the fibers in a composite to obtain a greater portion of their free swell absorbent capacity. In addition, permeability is generally maintained at suitable values because the development of higher internal stresses is alleviated or prevented.

In another embodiment, one of the embodiments characterized in one of the three preceding paragraphs (i.e., a low fiber-bed friction angle fiber or low cohesion value fiber) is combined with one or more embodiments of a low gel-bed friction angle superabsorbent material described in U.S. Provisional Patent Application Serial No. 60/399877, entitled “Superabsorbent Materials Having Low, Controlled Gel-Bed Friction Angles and Composites Made From The Same,” filed on 30 Jul. 2002 (as stated above, this co-pending application is incorporated by reference).

The gel-bed cohesion value of the superabsorbent material (specifically, a superabsorbent material initially having a lower gel-bed cohesion value, such as one or more of the low gel-bed cohesion value superabsorbent materials described above) may be increased during swelling with a cohesion value increasing additive that is located within the superabsorbent material structures in combination with the water swellable, water insoluble polymer. In one embodiment of the present invention, the cohesion value increasing additive may be chitosan, which may create a sticky condition between anionic superabsorbent polymers, leading to a higher cohesion value. Other examples of such cohesion value increasing additives include, without limitation, sodium silicate, sodium aluminate, and alumino silicates.

The amount of fiber-bed cohesion value increasing additives, surfactants, or emulsifiers may be about 1.0% by weight of the dry fiber or less. Optionally, the amount of fiber-bed cohesion value increasing additives, surfactants, or emulsifiers may be about 10.0% by weight of the dry fiber or less. Additionally, the amount of fiber-bed cohesion value increasing additives, surfactants, or emulsifiers may be about 100.0% by weight of the dry fiber or less. The amount of fiber-bed cohesion value increasing additives, surfactants, or emulsifiers may be about 0.001% by weight of the dry fiber or greater. Optionally, the amount of fiber-bed cohesion value increasing additives, surfactants, or emulsifiers may be about 0.1% by weight of the dry fiber or greater. Additionally, the amount of fiber-bed cohesion value increasing additives, surfactants, or emulsifiers may be about 1.0% by weight of the dry fiber or greater.

In another embodiment of the present invention, the wet fiber-bed friction angle is about 120% or more of the dry fiber-bed friction angle of a given fiber (e.g., a natural fiber; a synthetic fiber; or some combination thereof). Suitably, the wet fiber-bed friction angle is about 130% or more of the dry fiber-bed friction angle of a given fiber or fiber blend (e.g., a natural fiber; a synthetic fiber; or some combination thereof). Particularly, the wet fiber-bed friction angle is about 140% or more of the dry fiber-bed friction angle of a given fiber or fiber blend (e.g., a natural fiber; a synthetic fiber; or some combination thereof). Fiber having these characteristics is advantageous in a composite having an open structure (either initially, or when fully swollen) such that it is desirable for the composite to maintain the open structure even when loads are imposed.

In another embodiment, the embodiment characterized in the preceding paragraph (i.e., a high cohesion value fiber) is combined with a high gel-bed friction angle superabsorbent material described in U.S. Provisional Patent Application Serial No. 60/399794, entitled “Superabsorbent Materials Having High, Controlled Gel-Bed Friction Angles and Composites Made From The Same,” filed on 30 Jul. 2002 (as stated above, this co-pending application is incorporated by reference).

The additives, such as the friction angle increasing additives and friction angle reducing additives, which may alter the friction angle of superabsorbent materials, may be delivered either directly or indirectly to the superabsorbent. Direct delivery could occur through release from the superabsorbent material itself while indirect delivery could occur from fiber or some other component positioned within or adjacent the superabsorbent material and/or the absorbent composite. Furthermore, friction angle altering additives may be delivered gradually over some time period through release from any of the existing components present in the absorbent composite or as the result of some chemical reaction devised to release the friction angle altering additive at the most desirable moment. For example, the friction angle altering additive may be attached to the surface of the superabsorbent material or embedded within its interior, or it may be loaded onto and/or into some other component present in the absorbent composite, including but not limited to the fibrous material. The friction angle altering additive may be available immediately, leading to immediate alteration of the friction angle, or because of a chemical reaction or diffusion or some other mechanism, gradually alter the friction angle in the desired manner at some desired time.

It may be desirable to treat the superabsorbent material, the fiber and/or fibrous matrix, and/or other components that may be used in an absorbent composite with a friction angle altering additive, such as the friction angle reducing additive, the friction angle increasing additive and/or combinations thereof, to provide materials having desired initial friction angles. The material treated with the friction angle altering additive to provide a desired initial friction angle may then be treated with additional friction angle altering additives in accordance with the present invention.

The controlled fiber-bed friction angle fiber materials of the present invention may be incorporated into absorbent composites useful in absorbent articles. The various controlled fiber-bed friction angle fiber materials of the present invention may be used in various composite structures known in the art, such as described above, including fibrous composites such as meltblown, airlaid, airformed, and spunbond composites and foam composites.

In accordance with one embodiment of the present invention, a plurality of fibers comprises wettable natural fibers having a fiber-bed friction angle of about 35 degrees or less upon wetting. In the alternative, the fiber-bed friction angle may be about 25 degrees or less. The plurality of fibers may further comprise a friction angle reducing additive in combination with the wettable natural fibers. The friction angle reducing additive may be selected from the group consisting essentially of glycerol, mineral oil, silicone oil, oleic acid, polysaccharides, polyethylene oxides, and combinations thereof.

In some instances, the plurality of fibers may further comprise an emulsifier in combination with the wettable natural fibers. The emulsifier may be selected from the group consisting essentially of phosphatidylcholine, lecithin, and combinations thereof. The plurality of fibers may further comprise a surfactant in combination with the wettable natural fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

In accordance with another embodiment of the present invention, an absorbent composite may comprise a water swellable, water insoluble superabsorbent material and a plurality of wettable natural fibers. The wettable natural fibers may have a fiber-bed friction angle of about 35 degrees or less upon wetting. In the alternative, the fiber-bed friction angle may be about 25 degrees or less.

The water swellable, water insoluble superabsorbent material may have a first gel-bed friction angle at a superabsorbent material swelling level of about 2.0 grams of 0.9 weight percent sodium chloride solution/gram of the superabsorbent material and gel-bed friction angles, at superabsorbent material swelling levels greater than about 2.0 grams of 0.9 weight percent sodium chloride solution/gram of the superabsorbent material. The gel-bed friction angles may be substantially equal to or less than the first gel-bed friction angle. The first gel-bed friction angle may be about 20 degrees or less. (The term “substantially” when used herein in regard with friction angle, means within +/− one degree. The term “substantially” when used herein in regard with cohesion value, means within +/− 100 Pascals.)

The water swellable, water insoluble superabsorbent material may be selected from the group consisting essentially of natural materials, modified natural materials, synthetic materials, and combinations thereof. The absorbent composite may further comprise a friction angle reducing additive in combination with the plurality of wettable natural fibers. The friction angle reducing additive may be selected from the group consisting essentially of glycerol, mineral oil, silicone oil, oleic acid, polysaccharides, polyethylene oxides, and combinations thereof. The absorbent composite may further comprise an emulsifier in combination with the plurality of wettable natural fibers. The emulsifier may be selected from the group consisting essentially of phosphatidylcholine, lecithin, and combinations thereof. The absorbent composite may further comprise a surfactant in combination with the plurality of wettable natural fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

In accordance with another embodiment of the present invention, a plurality of fibers may comprise wettable fibers having a fiber-bed friction angle of about 50 degrees or greater upon wetting. In the alternative, the fiber-bed friction angle may be about 55 degrees or greater. The plurality of fibers may further comprise a friction angle increasing additive in combination with the wettable fibers. The friction angle increasing additive may be selected from the group consisting essentially of chitosan, sodium silicate, sodium aluminate, alumino silicates, and combinations thereof. The wettable fibers may be selected from the group consisting essentially of natural fibers, synthetic fibers, and combinations thereof.

The plurality of fibers may further comprise an emulsifier in combination with the wettable natural fibers. The emulsifier may be selected from the group consisting essentially of phosphatidylcholine, lecithin, and combinations thereof. The plurality of fibers may further comprise a surfactant in combination with the wettable natural fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

In accordance with another embodiment of the present invention, an absorbent composite may comprise a water swellable, water insoluble superabsorbent material and a plurality of wettable fibers having a fiber-bed friction angle of about 50 degrees or greater upon wetting. In the alternative, the fiber-bed friction angle may be about 55 degrees or greater. The absorbent composite may further comprise a friction angle increasing additive in combination with the wettable fibers. The friction angle increasing additive may be selected from the group consisting essentially of chitosan, sodium silicate, sodium aluminate, alumino silicates, and combinations thereof. The wettable fibers may be selected from the group consisting essentially of natural fibers, synthetic fibers, and combinations thereof. The absorbent composite may further comprise an emulsifier in combination with the wettable fibers.

The emulsifier may be selected from the group consisting essentially of phosphatidylcholine, lecithin, and combinations thereof. The absorbent composite may further comprise a surfactant in combination with the wettable fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

The water swellable, water insoluble superabsorbent material may have a first gel-bed friction angle at a superabsorbent material swelling level of about 5.0 grams of 0.9 weight percent sodium chloride solution/gram of the superabsorbent material and gel-bed friction angles, at superabsorbent material swelling levels greater than about 5.0 grams of 0.9 weight percent sodium chloride solution/gram of the superabsorbent material. The gel-bed friction angles may be substantially equal to or greater than the first gel-bed friction angle. The first gel-bed friction angle may be about 30 degrees or greater. The water swellable, water insoluble superabsorbent material may be selected from the group consisting essentially of natural materials, modified natural materials, synthetic materials, and combinations thereof.

In accordance with another embodiment of the present invention, a plurality of fibers may comprise wettable fibers having a dry fiber-bed friction angle and a wet fiber-bed friction angle. The wet fiber-bed friction angle may be about 80% or less than the dry fiber-bed friction angle. In the alternative, the wet fiber-bed friction angle may about 40% or less than the dry fiber-bed friction angle. The plurality of fibers may further comprise a friction angle reducing additive in combination with the wettable fibers. The friction angle reducing additive may be selected from the group consisting essentially of glycerol, mineral oil, silicone oil, oleic acid, polysaccharides, polyethylene oxides, and combinations thereof.

The plurality of fibers may further comprise an emulsifier in combination with the wettable fibers. The emulsifier may be selected from the group consisting essentially of phosphatidylcholine, lecithin, and combinations thereof. The plurality of fibers may further comprise a surfactant in combination with the wettable fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof. The wettable fibers may be selected from the group consisting essentially of natural fibers, synthetic fibers, and combinations thereof.

In accordance with another embodiment of the present invention, an absorbent composite may comprise a water swellable, water insoluble superabsorbent material and a plurality of wettable fibers. The plurality of wettable fibers may have a dry fiber-bed friction angle and a wet fiber-bed friction angle. The wet fiber-bed friction angle may be about 80% or less than the dry fiber-bed friction angle. In the alternative, the wet fiber-bed friction angle may be about 40% or less than the dry fiber-bed friction angle.

The water swellable, water insoluble superabsorbent material may have a first gel-bed friction angle at a superabsorbent material swelling level of about 2.0 grams of 0.9 weight percent sodium chloride solution/gram of the superabsorbent material and gel-bed friction angles, at superabsorbent material swelling levels greater than about 2.0 grams of 0.9 weight percent sodium chloride solution/gram of the superabsorbent material. The gel-bed friction angle may be substantially equal to or less than the first gel-bed friction angle. The first gel-bed friction angle may be about 20 degrees or less.

The water swellable, water insoluble superabsorbent material may be selected from the group consisting essentially of natural materials, modified natural materials, synthetic materials, and combinations thereof. The absorbent composite may further comprise a friction angle reducing additive in combination with the plurality of wettable fibers. The friction angle reducing additive may be selected from the group consisting essentially of glycerol, mineral oil, silicone oil, oleic acid, polysaccharides, polyethylene oxides, and combinations thereof.

The absorbent composite may further comprise an emulsifier in combination with the plurality of wettable fibers. The emulsifier may be selected from the group consisting essentially of phosphatidylcholine, lecithin, and combinations thereof. The absorbent composite may further comprise a surfactant in combination with the plurality of wettable fibers. The surfactant may be selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof. The wettable fibers may be selected from the group consisting essentially of natural fibers, synthetic fibers, and combinations thereof.

In accordance with another embodiment of the present invention, a plurality of fibers, comprising wettable fibers having a dry fiber-bed cohesion value and a wet fiber-bed cohesion value wherein the wet fiber-bed cohesion value is about 120% or less than the dry fiber-bed cohesion value. In alternative, the wet fiber-bed cohesion value may be about 80% or less than the dry fiber-bed cohesion value. The wettable fibers may be selected from the group consisting essentially of natural fibers, synthetic fibers, and combinations thereof.

In accordance with another embodiment of the present invention, an absorbent composite may comprise a water swellable, water insoluble superabsorbent material and a plurality of wettable fibers having a dry fiber-bed cohesion value and a wet fiber-bed cohesion value. The wet fiber-bed cohesion value may be about 120% or less than the dry fiber-bed cohesion value. In the alternative, the wet fiber-bed cohesion value may be about 80% or less than the dry fiber-bed cohesion value.

The water swellable, water insoluble superabsorbent material may have a first gel-bed friction angle at a superabsorbent material swelling level of about 2.0 grams of 0.9 weight percent sodium chloride solution/gram of the superabsorbent material and gel-bed friction angles, at superabsorbent material swelling levels greater than about 2.0 grams of 0.9 weight percent sodium chloride solution/gram of the superabsorbent material. The gel-bed friction angles may be substantially equal to or less than the first gel-bed friction angle. The first gel-bed friction angle may be about 20 degrees or less.

The water swellable, water insoluble superabsorbent material may selected from the group consisting essentially of natural materials, modified natural materials, synthetic materials, and combinations thereof. The wettable fibers may be selected from the group consisting essentially of natural fibers, synthetic fibers, and combinations thereof.

In accordance with another embodiment of the present invention, a plurality of fibers may comprise wettable natural fibers having a wet fiber-bed cohesion value of about 5,000 Pascals or less. In the alternative, the wet fiber-bed cohesion value may be about 2,500 Pascals or less. The wettable fibers may be selected from the group consisting essentially of natural fibers, synthetic fibers, and combinations thereof.

Low superabsorbent material gel-bed cohesion values may be obtained through non-conventional manufacturing processes that produce superabsorbent material structures possessing low-friction surfaces (e.g., smooth surfaces). Low superabsorbent material gel-bed cohesion values may also be obtained by treatment of superabsorbent materials with cohesion value reducing additives that decrease cohesion value upon becoming wet. Examples of such cohesion value reducing additives include, without limitation, glycerol, oils such as mineral oil and silicone oil, oleic acid, polysaccharides, polyethylene oxides.

The amount of fiber-bed cohesion value reducing additives, surfactants, or emulsifiers may be about 1.0% by weight of the dry fiber or less. Optionally, the amount of fiber-bed cohesion value reducing additives, surfactants, or emulsifiers may be about 10.0% by weight of the dry fiber or less. Additionally, the amount of fiber-bed cohesion value reducing additives, surfactants, or emulsifiers may be about 100.0% by weight of the dry fiber or less. The amount of fiber-bed cohesion value reducing additives, surfactants, or emulsifiers may be about 0.001% by weight of the dry fiber or greater. Optionally, the amount of fiber-bed cohesion value reducing additives, surfactants, or emulsifiers may be about 0.1% by weight of the dry fiber or greater. Additionally, the amount of fiber-bed cohesion value reducing additives, surfactants, or emulsifiers may be about 1.0% by weight of the dry fiber or greater.

In accordance with another embodiment of the present invention, an absorbent composite may comprise a water swellable, water insoluble superabsorbent material and a plurality of wettable fibers having a wet fiber-bed cohesion value of about 5,000 Pascals or less. In the alternative, the wet fiber-bed cohesion value may be about 2,500 Pascals or less. The water swellable, water insoluble superabsorbent material may be selected from the group consisting essentially of natural materials, modified natural materials, synthetic materials, and combinations thereof. The wettable fibers may be selected from the group consisting essentially of natural fibers, synthetic fibers, and combinations thereof.

In accordance with another embodiment of the present invention, a plurality of fibers may comprise wettable fibers having a dry fiber-bed friction angle and a wet fiber-bed friction angle. The wet fiber-bed friction angle may be about 120% or greater than the dry fiber-bed friction angle. In the alternative, the wet fiber-bed friction angle may be about 140% or greater than the dry fiber-bed friction angle. The wettable fibers may be selected from the group consisting essentially of natural fibers, synthetic fibers, and combinations thereof.

In accordance with another embodiment of the present invention, an absorbent composite may comprise a water swellable, water insoluble superabsorbent material and a plurality of wettable fibers having a dry fiber-bed friction angle and a wet fiber-bed friction angle. The wet fiber-bed friction angle may be about 120% or greater than the dry fiber-bed friction angle. In the alternative, the wet fiber-bed friction angle may be about 140% or greater than the dry fiber-bed friction angle.

The water swellable, water insoluble superabsorbent material may have a first gel-bed friction angle at a superabsorbent material swelling level of about 5.0 grams of 0.9 weight percent sodium chloride solution/gram of the superabsorbent material and gel-bed friction angles, at superabsorbent material swelling levels greater than about 5.0 grams of 0.9 weight percent sodium chloride solution/gram of the superabsorbent material. The gel-bed friction angles may be substantially equal to or greater than the first gel-bed friction angle. The first gel-bed friction angle may be about 30 degrees or greater. The water swellable, water insoluble superabsorbent material is selected from the group consisting essentially of natural materials, modified natural materials, synthetic materials, and combinations thereof. The wettable fibers may be selected from the group consisting essentially of natural fibers, synthetic fibers, and combinations thereof.

### Friction Angle Determination

### Test Procedure

Ring Shear Tester

Fiber

Purpose: To Calculate Friction Angle and Effective Cohesion Value from the Normal Force Applied and the Shear Force Used

Equation: [symbol] =C+ [symbol] (tangent φ)

shear force needed for smooth

| | | | | |
|---|---|---|---|---|
| Variables | τ | movement | | (tau) |
| | | effective cohesion value | | |
| | | at 0 normal force | | |
| | C | (or σ = 0) | | |
| | | normal force | (could also use | |
| | σ | applied | “N”) | (sigma) |
| | φ | friction angle | (phi) | |
| | | linear friction | (phi | |
| | φlinear | angle | lin) | |

File Labeling

Purpose: File and Bulk Solids label should include the Fiber/Code number, the normal load ramp, Wet or Dry-type, and cell ring information

Example: Fiber 1 (CR1654) Wet—fully saturated in cell ring #2 with T1A normal load ramp

File name: F01W1TA2

| | For |
|---|---|
| F | Fiber |
| 01 | Number of Fiber/Code |
| TA | For Load Ramp |
| W1 | Wet (from Wet or Dry) and type of |
| | wetting |
| | Ring Cell |
| 2 | Number |

Procedure:

Fiber Preparation

| | | |
|---|---|---|
| 1 | Determine Fiber Type, Basis | Example: CR1654 800 |
| | Weight and Wet/Dry | gsm Wet |
| 2 | Make Handsheets required at given | Example 10 × 17 in2 @ |
| | Basis Weight | 800 gsm |
| 3 | Cut Circular Ring shapes out of | |
| | Handsheets—Dimensions 34.61 | |

| | |
|---|---|
| | in2 |
| 4 | Collect Dry Weight in |
| | grams |
| 5 | For Dry Fiber readings Skip to Step# 21, For Wet Fiber |
| | readings go onto to Step# 6 |
| 6 | Place Sample into plastic soaking ring chamber |
| 7 | Place chamber into Fluid Box |
| | Reservoir |
| 8 | Place Ring Plate on top of sample in ring |
| | chamber |
| 9 | Fill Fluid Box with ½ inch Saline— |
| | 0.9% |
| 10 | Wait 10-15 minutes for soaking and swelling |
| 11 | Pull out Ring Chamber (with sample and plate) from Fluid Box |
| | Reservoir |
| 12 | Wipe Assembly to keep from |
| | dripping |
| 13 | Flip Chamber/Sample/Plate quickly and place on top of 1 blotter |
| 14 | Push out Sample and Plate (now under sample) from Ring |
| | Chamber |
| 15 | Place 5+ blotters on top of sample and flip all— |
| | blotter/plate/sample/blotters |
| 16 | Remove top blotter (former bottom) and Ring Plate, sample |
| | just remains on blotters |
| 17 | Cover Sample with 5 new blotters, gently press only for contact |
| 18 | Allow for adsorption—15 minutes |
| 19 | Flip sample/blotters and allow for adsorption on other side—15 |
| | minutes |
| 20 | Remove top blotters |
| 21 | Peal away forming tissue from sample with forceps— |
| | gently |
| 22 | Flip sample and peal away other forming |
| | tissue |
| 23 | Place sample into Ring Cell #2 |
| 24 | Now either finish Computer Set-up or Go onto |
| | Running Test |

NOTE: *During Fiber Preparation Step 10 do Computer Set-up,
Calibration must be done before Step 23

| | Computer Set-up and | |
|---|---|---|
| | Calibration | |
| 1 | Turn on Computer and Ring Shear Tester—wait 30 | |
| | minutes | |
| 2 | After 30 minutes, Press Start Icon and up to | |
| | Programs—Press | |
| | Select MS | |
| 3 | DOS | |
| 4 | When in MS DOS after C:>WINDOWS>, write in cd . . . , then | |
| | enter | |
| 5 | After prompt: C:>, write in: cd rsv, then enter | |
| 6 | After prompt: RSV:>, write in: rstctrl, then | |
| | enter | |
| 7 | It will tell you to switch on ring shear tester—confirm that it is | |
| | still on, press space bar | |
| 8 | Tester will do some initiation steps—wait | |
| 9 | Computer will mention “check offset values . . . ”, If the | |
| | same press Y for Yes | |
| 10 | Place empty ring shear cell with lid on to tester and connect | |
| | hanger, press space bar | |
| 11 | It will test upper limit, wait, | no tie rods here |
| | press space bar | |
| 12 | It will test lower limit, wait, | no tie rods here |
| | press space bar | |
| 13 | Note that there are no tie rods on | |
| | yet, press space bar | |
| 14 | Press F1 for “TESTS” | |
| 15 | Press F1 for “Flow Properties” | |
| 16 | Press F4 for “Read Settings from | |
| | Control File” | |
| 17 | At “Bulk Solids” enter name of | See File |
| | file/experiment, press enter | Labeling ex:F01W; |
| 18 | At “Order” enter in information of | Ex. CR1564 Wet T1A |
| | sample/test, press enter | |
| 19 | At “Ring Shear #” enter Cell # ex. 2 | |
| 20 | At “Total Mass” stop and finish Fiber Preparation if | |
| | necessary | |
| 21 | Go on to Running Test | |
| | Running Test: Ring Shear Tester | |
| 1 | Weigh Filled Ring Shear Cell, from Fiber Preparation Step | |
| | 21/22* | |
| 2 | Record Weight | example 3338.5 |
| 3 | Insert Filled Ring Shear Cell onto the Tester, click into | |
| | place | |
| 4 | On computer, at “Total Mass” enter the recorded weight, press | |
| | enter | |
| 5 | For presettings, press Y for Yes | |
| 6 | At “Control File Prefix:: enter T1A, then enter | |
| 7 | It will give a range, wait | |
| 8 | It will ask “Start Measuring with These Settings”, | |
| | enter Y for Yes | |
| 9 | It will say to put the bottom ring on, the top on (evenly), connect | |
| | hanger—forgot the weight | |
| | confirm bottom is on, put on top, connect counter weight, | |
| | connect hanger, press space bar | |
| | It will ask you to confirm the weight is on, confirm and press | |
| 10 | space bar | |
| 11 | It will ask you to confirm that the tie rods are not on, | |
| | confirm and press space bar | |
| 12 | It will recheck force values, when prompt—press space | |
| | bar | |
| 13 | At prompt, place tie rods on, place R and L tie rods, adjust | |
| | center (if need), press space bar | |
| 14 | Test starts running (1-2 hours total), It will start with | |
| | the pre-shearing | |
| | Press F2 to change to Normal | |
| 15 | Velocity | |
| 16 | Record the Sample Mass number | example 124.40 |

| | | |
|---|---|---|
| | 16 | When the pre-shear force is at equilibrium (flat line) it should |
| | | automatically change to the first normal force 500, and then |
| | | continue on with testing each normal force |
| | 17 | After last normal force finishes, it will say test complete |
| | 18 | Record values phiSF (degrees) and FC[Pa] |
| | | press space bar and it will show values, press space bar |
| | 19 | again |
| | 20 | It will ask you to save file, enter Y for Yes |
| | | enter file name—should be the same as the “Bulk |
| | | Solids” label, press |
| | 21 | space bar |
| | 22 | It will ask you to store data, enter Y for Yes |
| | | To do another test select F1 for “Flow properties” and |
| | | repeat from step 15 in Comput |
| | 23 | set up |
| | 24 | To leave the program press Esc for main |
| Or | | menu |
| | 25 | Press Esc, to exit |
| | | program |
| | 26 | Press Y for Yes to |
| | | terminate |
| | 27 | Close window for DOS, and press Start and up to Shut |
| | | down |

### EXAMPLES

To demonstrate aspects of the present invention, fibers NB416, available from Weyerhaeuser, a business having offices in Federal Way, Wash., and Sulfatate HJ, available from Rayonier, a business having offices in Jesup, Ga.; were treated to alter the fiber-bed friction angle and fiber-bed cohesion. All airformed fiber-beds were made to a basis weight about 800 grams per square meter with densities about 0.10 grams per cubic centimeter. Those airformed fiber-beds that included treated fiber were made to basis weight about 800 grams per square meter with densities about 0.10 grams per cubic centimeter based upon dry untreated component (fiber) only; they were adjusted for the treatment presence.

Treatments used within these examples were either sprayed onto or printed onto both sides of the fiber roll board to achieve desired add on levels. The fibers were then fiberized with a Kamas fiberizer, commercially available from Kamas Industri AB located Vellinge, Sweden, at settings that gave a 95 or more percentage of fiberization as set forth in the Kamas Cell Mill H.01 manual. The fiberized treated fibers were used to make airformed fiber-beds and airformed composites.

Control

The fiber-bed friction angle and fiber-bed cohesion value of commercial fibers were measured as controls in dry and wet states. Fiber available from various sources was tested in accordance with the procedure outlined above. The results are presented in Table 1 below. The tested fibers were: (1) fiber designated as CR1654, available from Bowater, a business having offices in Childersburg, Ala.; (2) fiber designated as Bahia Sul STD, available from Bahia Sul, a business having offices in Sao Paulo, Brazil; (3) fiber designated as Sulfatate HJ, available from Rayonier, a business having offices in Jesup, Ga.; and (4), (5), (6) fiber designated as NB416, ND416, and NHB416, each of which is available from Weyerhaeuser, a business having offices in Federal Way, Wash.

TABLE 1
Summary of fiber-bed mechanical property data—Controls

| | | Wet | Dry Effective | Wet Effective |
|---|---|---|---|---|
| | Dry Friction | Friction | Cohesion | Cohesion |
| | Angle | Angle | (Pa = | (Pa = |
| Fiber Name | (degrees) | (degrees) | 0.001 KPa) | 0.001 KPa) |
| CR1654 | 47 | 46 | 3919 | 6006 |
| Bahia Sul | 41 | 42 | 2801 | 6216 |
| STD | | | | |
| Sulfatate HJ | 43 | 42 | 3148 | 7333 |
| NB416 | 48 | 43 | 4356 | 7488 |
| ND416 | 50 | 45 | 4043 | 7741 |
| NHB416 | 46 | 41 | 4307 | 6279 |

Sample 1

Fiber designated as NB416, available from Weyerhaeuser, a business having offices in Federal Way, Wash., was coated with Mineral Oil, CAS 8012-95-1, available from Mallinckrodt Baker, having business offices in Phillipsburg, N.J., in a ratio of 0.2 grams of additive per 1.0 grams of fiber. An airformed fiber-bed was made of the coated fluff fiber. The dry fiber-bed friction angle and dry fiber-bed cohesion value of the coated fiber was measured using the procedure outlined above. The dry fiber-bed friction angle and dry fiber-bed cohesion value of Sample 1 were found to be 46 degrees and 3172 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the coated fiber were measured using the procedure outlined above. The wet fiber-bed friction angle and wet fiber-bed cohesion value of Sample 1 were found to be 37 degrees and 5320 Pascals respectively, summarized in Table 2.

Sample 2

Fiber designated as Sulfatate HJ, available from Rayonier, a business having offices in Jesup, Ga., was coated with Mineral Oil (from Sample 1) in a ratio of 0.2 grams of additive per 1.0 grams of fiber. An airformed fiber-bed was made of the coated fluff fiber. The dry fiber-bed friction angle and dry fiber-bed cohesion value of the coated fiber were measured using the procedure outlined above. The dry fiber-bed friction angle and dry fiber-bed cohesion value of Sample 2 were found to be 42 degrees and 3122 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the coated fiber were measured as the previous. The wet fiber-bed friction angle and wet fiber-bed cohesion value of Sample 2 were found to be 40 degrees and 3734 Pascals respectively, summarized in Table 2.

Sample 3

Fiber designated as NB416, available from Weyerhaeuser, a business having offices in Federal Way, Wash., was coated with Mineral Oil (from Sample 1) and Lecithin, CAS 8002-43-5, available from Spectrum Quality Products, Inc., a business having offices in Gardena, Calif., in a ratio of 0.2 grams of additive/coating per 1.0 grams of fiber. The coating/additive was a mixture containing 0.95 grams of mineral oil and 0.05 grams of Lecithin for every 1.0 gram of additive. An airformed fiber-bed was made of the coated fluff fiber. The dry fiber-bed friction angle and dry fiber-bed cohesion value of the coated fiber were measured using the procedure outlined above. The dry fiber-bed friction angle and dry fiber-bed cohesion value of Sample 3 were found to be 29 degrees and 1155 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the coated fiber were measured as the previous. The wet fiber-bed friction angle and wet fiber-bed cohesion value of Sample 3 were found to be 40 degrees and 3613 Pascals respectively, summarized in Table 2.

Sample 4

Fiber designated as Sulfatate HJ, available from Rayonier, a business having offices in Jesup, Ga., was blended with T255, a synthetic KoSa Celbond® bicomponent fiber available from KoSa, at a ratio of 0.5 grams NB416 and 0.5 grams of T255 per 1.0 grams of fiber. An airformed fiber-bed was made of the blended fluff fiber. The dry fiber-bed friction angle and dry fiber-bed cohesion value of the blended fiber were measured using the procedure outlined above. The dry fiber-bed friction angle and dry fiber-bed cohesion value of Sample 4 were found to be 31 degrees and 1018 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the blended fiber were measured as the previous. The wet fiber-bed friction angle and wet fiber-bed cohesion value of Sample 4 were found to be 30 degrees and 1073 Pascals respectively, summarized in Table 2.

Sample 5

Fiber designated as NB416, available from Weyerhaeuser, a business having offices in Federal Way, Wash., was blended with T255, a synthetic KoSa Celbond® bicomponent fiber available from KoSa, at a ratio of 0.5 grams NB416 and 0.5 grams of T255 per 1.0 grams of fiber. An airformed fiber-bed was made of the blended fluff fiber. The dry fiber-bed friction angle and dry fiber-bed cohesion value of the blended fiber were measured using the procedure outlined above. The dry fiber-bed friction angle and dry fiber-bed cohesion value of Sample 5 were found to be 27 degrees and 910 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the blended fiber were measured as the previous. The wet fiber-bed friction angle and wet fiber-bed cohesion value of Sample 5 were found to be 23 degrees and 1597 Pascals respectively, summarized in Table 2.

Sample 6

Fiber designated as NB416, available from Weyerhaeuser, a business having offices in Federal Way, Wash., was blended with T255, a synthetic KoSa Celbond® bicomponent fiber available from KoSa, at a ratio of 0.65 grams NB416 and 0.35 grams of T255 per 1.0 grams of fiber. An airformed fiber-bed was made of the blended fluff fiber. The dry fiber-bed friction angle and dry fiber-bed cohesion value of the blended fiber were measured using the procedure outlined above. The dry fiber-bed friction angle and dry fiber-bed cohesion value of Sample 6 were found to be 37 degrees and 1299 Pascals respectively, summarized in Table 2. A duplicate airformed fiber-bed was made and swollen with 0.9% aqueous NaCl solution, following the method given above. The wet fiber-bed friction angle and wet fiber-bed cohesion value of the blended fiber were measured as the previous. The wet fiber-bed friction angle and wet fiber-bed cohesion value of Sample 6 were found to be 32 degrees and 2028 Pascals respectively, summarized in Table 2.

TABLE 2
Summary of fiber-bed mechanical property data-Samples 1-6

| | | Wet | Dry Effective | Wet Effective |
|---|---|---|---|---|
| | Dry Friction | Friction | Cohesion | Cohesion |
| | Angle | Angle | (Pa = | (Pa = |
| Fiber Name | (degrees) | (degrees) | 0.001 KPa) | 0.001 KPa) |
| NB416 | 48 | 43 | 4356 | 7488 |
| Sulfatate HJ | 43 | 42 | 3148 | 7333 |
| Sample 1 | 46 | 37 | 3172 | 5320 |
| Sample 2 | 42 | 40 | 3122 | 3734 |
| Sample 3 | 29 | 40 | 1155 | 3613 |
| Sample 4 | 31 | 30 | 1018 | 1073 |
| Sample 5 | 27 | 23 | 910 | 1597 |
| Sample 6 | 37 | 32 | 1299 | 2028 |

While the embodiments of the present invention described herein are presently preferred, various modifications and improvements may be made without departing from the spirit and scope of the present invention. The scope of the present invention is indicated by the appended claims, and all changes that fall within the meaning and range of equivalents are intended to be embraced therein.

We claim:

1. A plurality of fibers, comprising wettable natural fibers having a fiber-bed friction angle of about 35 degrees or less upon wetting.

2. The plurality of fibers of claim 1, wherein the fiber-bed friction angle is about 25 degrees or less.

3. The plurality of fibers of claim 1, further comprising a friction angle reducing additive in combination with the wettable natural fibers.

4. The plurality of fibers of claim 3, wherein the friction angle reducing additive is selected from the group consisting essentially of glycerol, mineral oil, silicone oil, oleic acid, polysaccharides, polyethylene oxides, and combinations thereof.

5. The plurality of fibers of claim 3, further comprising an emulsifier in combination with the wettable natural fibers.

6. The plurality of fibers of claim 5, wherein the emulsifier is selected from the group consisting essentially of phosphatidylcholine, lecithin, and combinations thereof.

7. The plurality of fibers of claim 3, further comprising a surfactant in combination with the wettable natural fibers.

8. The plurality of fibers of claim 7, wherein the surfactant is selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

9. An absorbent composite, comprising:
a water swellable, water insoluble superabsorbent material; and,
a plurality of wettable natural fibers having a fiber-bed friction angle of about 35 degrees or less upon wetting.

10. The absorbent composite of claim 9, wherein the fiber-bed friction angle is about 25 degrees or less.

11. The absorbent composite of claim 9, further comprising a friction angle reduction additive in combination with the plurality of wettable natural fibers.

12. The absorbent composite of claim 11, wherein the friction angle reduction additive is selected from the group consisting essentially of glycerol, mineral oil, silicone oil, oleic acid, polysaccharides, polyethylene oxides, and combinations thereof.

13. The absorbent composite of claim 11, further comprising an emulsifier in combination with the plurality of wettable natural fibers.

14. The absorbent composite of claim 13, wherein the emulsifier is selected from the group consisting essentially of phosphatidylcholine, lecithin, and combinations thereof.

15. The absorbent composite of claim 11, further comprising a surfactant in combination with the plurality of wettable natural fibers.

16. The absorbent composite of claim 15, wherein the surfactant is selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

17. A plurality of fibers, comprising wettable fibers having a fiber-bed friction angle of about 50 degrees or greater upon wetting.

18. The plurality of fibers of claim 17, wherein the fiber-bed friction angle is about 55 degrees or greater.

19. The plurality of fibers of claim 17, further comprising a friction angle increasing additive in combination with the wettable fibers.

20. The plurality of fibers of claim 19, wherein the friction angle increasing additive is selected from the group consisting essentially of chitosan, sodium silicate, sodium aluminate, alumino silicates, and combinations thereof.

21. The plurality of fibers of claim 17, wherein the wettable fibers are selected from the group consisting essentially of natural fibers, synthetic fibers, and combinations thereof.

22. An absorbent composite, comprising:
a water swellable, water insoluble superabsorbent material; and,
a plurality of wettable fibers having a fiber-bed friction angle of about 50 degrees or greater upon wetting.

23. The absorbent composite of claim 22, wherein the fiber-bed friction angle is about 55 degrees or greater.

24. The absorbent composite of claim 22, further comprising a friction angle increasing additive in combination with the wettable fibers.

25. The absorbent composite of claim 24, wherein the friction angle increasing additive is selected from the group consisting essentially of chitosan, sodium silicate, sodium aluminate, alumino silicates, and combinations thereof.

26. The absorbent composite of claim 22, wherein the wettable fibers are selected from the group consisting essentially of natural fibers, synthetic fibers, and combinations thereof.

27. A plurality of fibers, comprising wettable fibers having a dry fiber-bed friction angle and a wet fiber-bed friction angle wherein the wet fiber-bed friction angle is about 80% of the dry fiber-bed friction angle or less.

28. The plurality of fibers of claim 27, wherein the wet fiber-bed friction angle is about 40% of the dry fiber-bed friction angle or less.

29. The plurality of fibers of claim 27, further comprising a friction angle reducing additive in combination with the wettable fibers.

30. The plurality of fibers of claim 29, wherein the friction angle reducing additive is selected from the group consisting essentially of glycerol, mineral oil, silicone oil, oleic acid, polysaccharides, polyethylene oxides, and combinations thereof.

31. The plurality of fibers of claim 29, further comprising an emulsifier in combination with the wettable fibers.

32. The plurality of fibers of claim 31, wherein the emulsifier is selected from the group consisting essentially of phosphatidylcholine, lecithin, and combinations thereof.

33. The plurality of fibers of claim 29, further comprising a surfactant in combination with the wettable fibers.

34. The plurality of fibers of claim 33, wherein the surfactant is selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

35. The plurality of fibers of claim 27, wherein the wettable fibers are selected from the group consisting essentially of natural fibers, synthetic fibers, and combinations thereof.

36. An absorbent composite, comprising:
a water swellable, water insoluble superabsorbent material; and,
a plurality of wettable fibers having a dry fiber-bed friction angle and a wet fiber-bed friction angle wherein the wet fiber-bed friction angle is about 80% of the dry fiber-bed friction angle or less.

37. The absorbent composite of claim 36, wherein the wet fiber-bed friction angle is about 40% of the dry fiber-bed friction angle or less.

38. The absorbent composite of claim 36, further comprising a friction angle reducing additive in combination with the plurality of wettable fibers.

39. The absorbent composite of claim 38, wherein the friction angle reducing additive is selected from the group consisting essentially of glycerol, mineral oil, silicone oil, oleic acid, polysaccharides, polyethylene oxides, and combinations thereof.

40. The absorbent composite of claim 38, further comprising an emulsifier in combination with the plurality of wettable fibers.

41. The absorbent composite of claim 40, wherein the emulsifier is selected from the group consisting essentially of phosphatidylcholine, lecithin, and combinations thereof.

42. The absorbent composite of claim 38, further comprising a surfactant in combination with the plurality of wettable fibers.

43. The absorbent composite of claim 42, wherein the surfactant is selected from the group consisting essentially of sorbitan monolaurate, compounds of the Triton series, compounds of the Brij series, polyoxyethylene (80) sorbitan monolaurate, polyoxyethylene sorbitan tetraoleate, alcohol amines, and combinations thereof.

44. The absorbent composite of claim 36, wherein the wettable fibers are selected from the group consisting essentially of natural fibers, synthetic fibers, and combinations thereof.

45. A plurality of fibers, comprising wettable fibers having a dry fiber-bed cohesion value and a wet fiber-bed cohesion value wherein the wet fiber-bed cohesion value is about 120% of the dry fiber-bed cohesion value or less.

46. The plurality of fibers of claim 45, wherein the wet fiber-bed cohesion value is about 80% of the dry fiber-bed cohesion value or less.

47. The plurality of fibers of claim 45, wherein the wettable fibers are selected from the group consisting essentially of natural fibers, synthetic fibers, and combinations thereof.

48. An absorbent composite, comprising:
a water swellable, water insoluble superabsorbent material; and,
a plurality of wettable fibers having a dry fiber-bed cohesion value and a wet fiber-bed cohesion value wherein the wet fiber-bed cohesion value is about 120% of the dry fiber-bed cohesion value or less.

49. The absorbent composite of claim 48, wherein the wet fiber-bed cohesion value is about 80% of the dry fiber-bed cohesion value or less.

50. The absorbent composite of claim 48, wherein the wettable fibers are selected from the group consisting essentially of natural fibers, synthetic fibers, and combinations thereof.

51. A plurality of fibers, comprising wettable natural fibers having a wet fiber-bed cohesion value of about 5,000 Pascals or less.

52. The plurality of fibers of claim 51, wherein the wet fiber-bed cohesion value is about 2,500 Pascals or less.

53. The plurality of fibers of claim 51, wherein the wettable fibers are selected from the group consisting essentially of natural fibers, synthetic fibers, and combinations thereof.

54. An absorbent composite, comprising:
a water swellable, water insoluble superabsorbent material; and,
a plurality of wettable fibers having a wet fiber-bed cohesion value of about 5,000 Pascals or less.

55. The absorbent composite of claim 54, wherein the wet fiber-bed cohesion value is about 2,500 Pascals or less.

56. The absorbent composite of claim 54, wherein the water swellable, water insoluble superabsorbent material is selected from the group consisting essentially of natural materials, modified natural materials, synthetic materials, and combinations thereof.

57. The absorbent composite of claim 54, wherein the wettable fibers are selected from the group consisting essentially of natural fibers, synthetic fibers, and combinations thereof.

58. A plurality of fibers, comprising wettable fibers having a dry fiber-bed friction angle and a wet fiber-bed friction angle wherein the wet fiber-bed friction angle is about 120% of the dry fiber-bed friction angle or greater.

59. The plurality of fibers of claim 58, wherein the wet fiber-bed friction angle is about 140% of the dry fiber-bed friction angle or greater.

60. The plurality of fibers of claim 58, wherein the wettable fibers are selected from the group consisting essentially of natural fibers, synthetic fibers, and combinations thereof.

61. An absorbent composite, comprising:
a water swellable, water insoluble superabsorbent material; and,
a plurality of wettable fibers having a dry fiber-bed friction angle and a wet fiber-bed friction angle wherein the wet fiber-bed friction angle is about 120% of the dry fiber-bed friction angle or greater.

62. The absorbent composite of claim 61, wherein the wet fiber-bed friction angle is about 140% of the dry fiber-bed friction angle or greater.

63. The absorbent composite of claim 61, wherein the wettable fibers are selected from the group consisting essentially of natural fibers, synthetic fibers, and combinations thereof.
